(19) United States
(12) Patent Application Publication
(10) Pub. No.: US 2025/0162873 A1
(43) Pub. Date: May 22, 2025

(54) COMPOSITE MATERIALS WITH TUNABLE POROSITY, PREPARATION AND USES THEREOF

(71) Applicant: Aspen Aerogels, Inc., Northborough, MA (US)

(72) Inventors: Zhifei Li, Marlborough, MA (US); Nicholas Zafiropoulos, Northborough, MA (US); Ted Hosang Lee, Marlborough, MA (US); Ryan Fedora, Northborough, MA (US); Justin Ward, Northborough, MA (US)

(73) Assignee: Aspen Aerogels, Inc., Northborough, MA (US)

(21) Appl. No.: 19/028,968

(22) Filed: Jan. 17, 2025

Related U.S. Application Data
(63) Continuation of application No. PCT/US2023/070427, filed on Jul. 18, 2023.
(60) Provisional application No. 63/410,652, filed on Sep. 28, 2022.
(60) Provisional application No. 63/390,845, filed on Jul. 20, 2022.
(60) Provisional application No. 63/390,838, filed on Jul. 20, 2022.
(60) Provisional application No. 63/390,832, filed on Jul. 20, 2022.
(60) Provisional application No. 63/390,825, filed on Jul. 20, 2022.

(51) Int. Cl. C01B 32/05; C01B 33/113

(52) U.S. Cl. CPC C01B 32/05; C01B 33/113; C01P 2002/02; C01P 2002/08; C01P 2004/01; C01P 2006/14; C01P 2006/40

(57) ABSTRACT

Provided herein are composite materials for use in an electrical energy storage system (e.g., high-capacity batteries) and methods for preparing the same. The composite materials of the present disclosure comprise a three-dimensional carbon network and optional silicon particles. The composite materials further comprise macropores, at least some of which are formed by carbonizing sacrificial particles dispersed throughout a three-dimensional network. The macropores advantageously provide a space to accommodate the strain and stress in the electrode structure due to volume changes of silicon (particles) during charging and discharging of the electrical energy storage systems.

### CROSS REFERENCES TO RELATED APPLICATIONS

This application is a continuation of International Patent Application No. PCT/US2023/070427, entitled “Silicon Nanoparticles Comprising a Sacrificial Layer, Composite Materials Including Them, Preparation and Uses Thereof”, filed Jul. 18, 2023, and which claims priority to and the benefit of U.S. Provisional Patent Application No. 63/390,832 entitled “Silicon Nanoparticles Comprising a Sacrificial Layer, Composite Materials Including Them, Preparation and Uses Thereof”, filed Jul. 20, 2022; U.S. Provisional Patent Application No. 63/390,838 entitled “Composite Materials Comprising Void Space, Preparation, and Uses Thereof”, filed Jul. 20, 2022; U.S. Provisional Patent Application No. 63/410,652 entitled “Porous Carbon Materials Comprising a Carbon Additive”, filed Sep. 28, 2022; U.S. Provisional Patent Application No. 63/390,845 entitled “Composite Materials with Tunable Porosity, Preparation, and Uses Thereof”, filed Jul. 20, 2022; and U.S. Provisional Patent Application No. 63/390,825 entitled “Functionalized Silicon Nanoparticles, Composite Materials that Comprise Them, Preparation and Uses Thereof”, filed Jul. 20, 2022, all of which are incorporated herein by reference.

### FIELD OF THE TECHNOLOGY

The present disclosure relates generally to porous composite materials comprising a three-dimensional carbon network having pores (e.g., macropores, micropores, and mesopores) dispersed throughout the carbon network.

### BACKGROUND

High-capacity battery materials e.g., lithium-ion batteries (LIBs) have been recognized as the most promising energy storage technology for a wide range of applications, from consumer electronics, electric vehicles to renewable energy storage. Despite varying requirements of diverse applications, Li-ion batteries with high capacities and long cycling lives are generally essential.

Silicon is one of the most promising anode materials for lithium-ion batteries because of the highest known theoretical capacity and abundance in the earth' crust. Silicon has been shown to have a high theoretical gravimetric capacity, approximately 4200 mAh/g, compared to only 372 mAh/g for graphite. Therefore, silicon (Si) active material has been considered as promising candidate for next-generation anodes in lithium-ion batteries (LIBs).

However, silicon is known to experience a significant “breathing effect” during insertion/deinsertion of lithium in the continuous charge-discharge processes, which undermines the advantage of silicon's high capacity. That is, the volume of Si can expand approximately 400% of its original size during lithiation (the insertion of lithium-ions into silicon), then reducing to a varying size during de-lithiation (the extraction of lithium-ions from silicon). This “breathing effect” causes serious structural degradation, particularly when the Si is supported on a three-dimensional carbon network. Structural damage to the three-dimensional carbon network results in losing specific capacity and increasing battery impedance. The significant volume change poses a real challenge for Si electrodes to retain its morphology over cycling.

Accordingly, improved methods for controlling, selecting, modifying, or improving the surface properties and morphology of three-dimensional carbon support networks is needed.

### SUMMARY

The present technology provides a porous composite material comprising macropores and/or micropores and/or mesopores. The porous composite material comprises a three-dimensional carbon network with pores distributed throughout the three-dimensional carbon network. The composite material provided herein further comprises optional silicon particles embedded in the three-dimensional carbon network. At least some of the pores are formed by carbonizing a plurality of sacrificial particles dispersed throughout a three-dimensional carbon network precursor material. The pore volume, pore sizes, and pore distribution of the three-dimensional carbon network can be controlled by adjusting synthetic parameters such as the method of creating the composite material, the size of the sacrificial material particles, the amount of sacrificial particles used, and the material used to form the sacrificial material. Electrochemically active materials (e.g., silicon or silica) disposed within the porous three-dimensional carbon networks disclosed herein are capable of repeated expansion and contraction without significantly damaging the three-dimensional carbon network.

In an aspect, the composite materials mainly include macropores. The presence of macropores, provides several advantages, including providing space to accommodate volume expansion of silicon particles (or other electrochemically active materials) during charging processes and stabilizing the composite material. Without wishing to be bound by theory, accommodating volume expansion of silicon particles may delay fracturing of the three-dimensional carbon network due to continuous charging and discharging battery cycles. The macropores can function as “absorber” to accommodate the strain and stress in the entire electrode structure due to the silicon volume change. That is, the existence of macropores may reserve space for silicon (particles) during volume expansion and buffer the mechanical pressure of the three-dimensional carbon network, resulting in significantly enhanced structural integrity.

In one aspect, without wishing to be bound by theory, the composite materials of the present technology comprising macropores may sustain the overall electrode integrity in terms of microscopic structure and electrical connectivity between Si particles (even pulverized) and current collector.

Macropores which sufficiently accommodate the volume expansion of the silicon particles provide not only free space for volume expansion accommodation but also serve as efficient channels for lithium ion (Li+) diffusion and the charge transfer kinetic thus improving battery power.

In one aspect, the materials provided in the present disclosure may advantageously prevent or mitigate rapid capacity fading (e.g., within at least 10 cycles) of high-capacity batteries.

The composite materials of the present technology can improve the performance of lithium-ion batteries, relative to lithium-ion batteries having electrodes which do not possess the composite material of the present disclosure, e.g., composite materials without voids, or composite materials with different pore size distributions.

Provided herein is a composite material comprising a three-dimensional carbon network. The three-dimensional carbon network comprises micropores, mesopores, and macropores. At least some of the macropores of the composite material disclosed herein is formed by carbonizing a plurality of sacrificial particles dispersed throughout a three-dimensional network. The macropores, in one aspect, constitute a volume fraction of greater than about 50% of a total pore volume of the three-dimensional carbon network and the micropores constitute a volume fraction of about 10% to about 50% of the total pore volume of the three-dimensional carbon network. The composite material has a skeletal density ranging from about 0.5 to about 2.5 g/cm³ as measured by mercury pycnometry.

In some aspects, the mesopores constitute a volume fraction of less than about 10% of the total pore volume three-dimensional carbon network or less than 5% of the total pore volume three-dimensional carbon network.

In one aspect, the macropores constitute a volume fraction of over about 50% of a total pore volume three-dimensional carbon network, the mesopores constitute a volume fraction of less than 10% of a total pore volume three-dimensional carbon network, and the micropores constitute a volume fraction equal to the remainder of the total pore volume three-dimensional carbon network.

In some aspects, the volume fraction of the macropores is at least 1.5 times the volume fraction of the micropores. The volume fraction of the macropores can be about 1.5 times the volume fraction of the micropores to about 2.5 times the volume fraction of the micropores. In some aspects, the volume fraction of the macropores is at least 10 times the volume fraction of the mesopores.

The three-dimensional carbon network of the composite materials described herein can have a total porosity of the three-dimensional carbon network of greater than about 10%.

The three-dimensional carbon network of the composite materials described herein can have a volume of the macropores of the three-dimensional carbon network of about 0.1 cm³/g to 0.3 cm³/g.

The three-dimensional carbon network of the composite materials described herein can have a total pore volume of the three-dimensional carbon network of about 0.1 cm³/g to about 0.4 cm³/g.

The three-dimensional carbon network of the composite materials described herein can have a BET surface area of the composite material of less than about 50 m²/g or less than about 25 m²/g.

The three-dimensional carbon network of the composite materials described herein can have a mercury-inaccessible volume ranging from 0.03 cm³/g to 0.25 cm³/g.

In some aspects, the composite material is in the form of a bead. The composite material can have a particle size of about 3 μm to about 25 μm. The composite material can have a particle size distribution D50 ranging from about 5 μm to about 20 μm.

In some aspects, the three-dimensional carbon network comprises amorphous carbon. In some aspects, the three-dimensional carbon network is a xerogel. In some aspects, the three-dimensional carbon network is an aerogel. In some aspects that three-dimensional carbon network is an ambigel, an aerogel-xerogel hybrid material, an aerogel-ambigel hybrid material, an aerogel-ambigel-xerogel hybrid material, or combinations thereof.

In some aspects, the composite material comprises about 20% to about 85% silicon. In some aspects, the silicon particles are dispersed throughout the three-dimensional carbon network. The macropores in the three-dimensional carbon network surround or encompass the silicon particles providing separation or space to accommodate “breathing” of the silicon. In some aspects, the silicon is entrapped within the three-dimensional carbon network.

The silicon in the composite material can be silicon particles. In an aspect, the silicon particles are disposed adjacent to the macropores. The silicon particles can have a particle size distribution D50 ranging from about 10 nm to about 100 μm. The silicon particles can be at least partially crystalline. The silicon particles have an oxygen content of about 2% to about 40%.

In one aspect, the total volume of the macropores is about 1 to about 5 times greater than a total volume of the silicon particles.

In one aspect, the composite material has a silicon loading of about 2 wt % to about 30 wt %, wherein the three-dimensional carbon network has a total porosity of about 5% to about 50%, and wherein the three-dimensional carbon network has a total pore volume of about 0.10 mL/g to about 0.40 mL/g.

In one aspect, the composite material has a silicon loading of about 30 wt % to about 70 wt %, wherein the three-dimensional carbon network has a total porosity of about 45% to about 70%, and wherein the three-dimensional carbon network has a total pore volume of about 0.40 mL/g to about 1.0 mL/g.

In one aspect, the composite material has a silicon loading of about 70 wt % to about 98 wt %, wherein the three-dimensional carbon network has a porosity of about 65% to about 75%, and wherein the three-dimensional carbon network has a porosity of about 0.90 mL/g to about 1.4 mL/g.

In another aspect, provided herein is a method of improving the performance of an energy storage system. The method includes incorporating the composite material of the disclosure into an electrode of a lithium-based energy storage device. In one aspect, the composite material has a gravimetric capacity between about 1200 mAh/g to about 3500 mAh/g when the composite material is incorporated into an electrode of a lithium-based energy storage device. In one aspect, the composite material comprises lithium or a lithium salt.

In yet another aspect, provided herein is an electrode comprising a composite material as described herein.

In a further aspect, provided herein is an energy storage device comprising an electrode that includes a composite material as described herein.

### BRIEF DESCRIPTION OF THE DRAWINGS

The technology will be more fully understood from the following detailed description taken in conjunction with the accompanying drawings. It should be noted that the relative sizes in figures are not necessarily to scale but are shown for explanation purposes only.

FIG. 1A and FIG. 1B illustrate an exemplary composite material comprising macropores in accordance with the present disclosure.

FIG. 1C illustrates an exemplary composite material comprising macropores wherein silicon particles are disposed at least partially in the macropores in accordance with the present disclosure.

FIG. 2A and FIG. 2B illustrate exemplary composite materials according to certain aspects of the present technology and a method of treating the composite materials to obtain composite materials comprising macropores.

FIG. 2C illustrates an exemplary composite material according to certain aspects of the present technology comprising a three-dimensional network, sacrificial materials, and silicon particles, wherein the silicon particles each include a coating layer made of sacrificial materials. FIG. 2C further illustrates an exemplary method of treating the composite material to obtain a composite material comprising macropores and silicon particles, wherein macropores at least partially surround or encompass the silicon particles.

FIG. 3 illustrates the steps of the method of preparing an exemplary composite material according to multiple aspects of the present disclosure.

FIG. 4A depicts photographs of a porous polyimide (PI) composite material made from carbon.

FIG. 4B depicts photographs of a porous PI composite material made from silicon/carbon.

FIG. 5A depicts photographs of a porous polyamic acid (PAA) composite material made from carbon.

FIG. 5B depicts photographs of a porous PAA composite material made from silicon/carbon.

### DETAILED DESCRIPTION

Silicon (Si) is considered to be a promising alternative LIB anode material. It forms Li₇Si₃, Li₁₂Si₇, Li₁₃Si₄, Li₁₅Si₄, and Li₂₂Si₅ silicon-lithium alloys during the alloying process, among which Li₁₅Si₄ has a capacity of 3579 mAh g⁻¹ (2194 Ah L⁻¹) at room temperature, which is the highest theoretical capacity known for the anode material. Therefore, incorporating as much silicon as possible within the anode is desirable.

At the same time, the average voltage platform of Si (0.4 V vs. Li/Li⁺) is higher than that of the graphite electrode (0.125 V vs. Li/Li⁺), which makes it possible to avoid lithium plating and dendritic lithium formation on the anode material surface during the lithiation process. As a result, the safety performance of the battery can be significantly improved. Also, Si has the advantages of abundant reserves in the earth's crust and low price, which fosters further the industrial interest to utilize silicon in batteries.

Despite these advantages, silicon still has severe shortcomings when used as an electrode material. The core problem for the utilization of Si in a LIB is its vast volume expansion during lithiation. Si electrode can expand by up to 400%, which is much more than 10% for the graphite electrode. The volume expansion leads to mechanical failure of the Si.

The mechanical failure may occur in multiple ways. First, Si particles are gradually pulverized due to the repeated volume change and lose electrical contact between the active and other components, including conductive carbon and binder, which causes the capacity to decrease sharply and the cycle performance to decline rapidly. Secondly, the volume change also gradually causes active material to peel off the current collector, resulting in an electrical contact loss between the active material and the current collector, and the electrode capacity reduction after the initial cycle. Third, the electrolyte is gradually degraded. This is because a solid electrolyte interphase (SEI) layer is fractured and reformed continuously due to the volume expansion/contraction behavior of the Si electrode during cycling, resulting in the continuous exposure of fresh Si surface to the electrolyte. As a result, electrolyte degradation takes place continually on the highly reducing freshly lithiated Si surface, thus leading to an irreversible capacity loss at each cycle and eventual cell death. Both the mechanical failure and the electrolyte degradation can make the Si electrode lose its electrochemical activity very rapidly in the cycling process.

The composite materials provided herein obviate or mitigate at least one disadvantage of Si when used as an electrode material. Without wishing to be bound by theory, in general, the composite materials provided herein may be able to accommodate changes in volume of the active Si material during battery operation. In general, composite materials of the present technology include tailored or designed macropores that accommodates changes in the volume of silicon or silicon particles incorporated within the composite material.

In the description below, several examples are provided in the context of aqueous Li-ion batteries because of the current prevalence and popularity of Li-ion technology. However, it will be appreciated that such examples are provided merely to aid in the understanding and illustration of the underlying techniques, and that these techniques may be similarly applied to various other metal-ion batteries, such as Li⁺, Na⁺, Mg²⁺, Ca²⁺, and Al³, and other aqueous metal-ion batteries. The composite material of the present disclosure can be used in other chemistries (e.g., batteries or catalysts) where active particles undergo significant volume changes during their operation (e.g., reversible reduction-oxidation reactions), including, for example, aqueous electrolyte-containing batteries.

### Definitions

The articles “a” and “an” are used herein to refer to one or to more than one (i.e., to at least one) of the grammatical object of the article.

Within the context of the present disclosure, the term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Within the context of the present disclosure, the term “aerogel” or “aerogel material” refers to a solid object, irrespective of shape or size, comprising a framework of interconnected solid structures, with a corresponding network of interconnected pores integrated within the framework, and containing gases such as air as a dispersed interstitial medium. As such, aerogels such as carbon aerogels of the present application are open non-fluid colloidal or polymer networks that are expanded throughout their whole volume by a gas. Aerogels (e.g., carbon aerogels) are generally prepared by removing the solvent from a gel (a solid network that contains a solvent) in a manner such that minimal or no contraction of the gel can be brought by capillary forces at its pore walls, in other words, by the removal of all swelling agents from a corresponding wet-gel without substantial volume reduction or network compaction. Methods of solvent removal include, but are not limited to, supercritical drying (or drying using supercritical fluids, such that the low surface tension of the supercritical fluid exchanges with the transient solvent within the gel), exchange of solvent with supercritical fluid, exchange of solvent with fluid that is subsequently transformed to the supercritical state, sub- or near-critical fluid drying, and sublimating a frozen solvent in a freeze-drying process. See for example, PCT Patent Application Publication No. WO2016127084A1.

Aerogels such as carbon-aerogels include a highly porous network of micro-, meso-, and macro-sized pores, and are generally characterized by the following physical and structural properties (according to nitrogen porosimetry testing and helium pycnometry) attributable to aerogels: (a) an average pore diameter ranging from about 2 nm to about 100 nm; (b) a porosity of at least 60% or more, and (c) a specific surface area of about 100 m²/g or more, such as from about 100 to about 1000 m²/g by nitrogen sorption analysis.

Aerogel materials of the present disclosure thus include any aerogels or other open-celled compounds, which satisfy the defining elements set forth in previous paragraphs.

As used herein, the terms “xerogel” and “ambigel” refer to gels comprising an open, non-fluid colloidal or polymer network that is formed by the removal of all swelling agents from a corresponding wet-gel without any precautions taken to avoid substantial volume reduction or compaction, such as under ambient pressure drying. In contrast to an aerogel (e.g,, a carbon aerogel), a xerogel, such as a carbon xerogel, generally comprises a compact structure. Xerogels experience substantial volume reduction during ambient pressure drying, and can have lower surface areas compared to aerogels, such as 0-100 m²/g, or from about 0 to about 20 m²/g as measured by nitrogen sorption analysis.

Within the context of the present disclosure, the term “continuous” refers to a layer free of gaps, holes, or any discontinuities. For example, a continuous layer that does not include two (or more) component materials physically separated (or spaced apart) within this layer.

As used herein, the term “uniform” refers to a variation in the thickness of a material e.g., the coating of the present disclosure of less than about 10%, less than about 5%, or less than about 1%.

Within the context of the present disclosure, the term “capacity” refers to the amount of specific energy or charge that a battery is able to store. Capacity is specifically measured as the discharge current that the battery can deliver over time, per unit mass. It is typically provided as Ampere-hours or milliAmpere-hours per gram (Ah/g or mAh/g) of total active material mass. For example, a battery with 1 Ah capacity can supply a current of one ampere for one hour or 0.5 amps for two hours, etc. Therefore, 1 Ampere-hour (Ah) is the equivalent of 3,600 coulombs of electrical charge. Similarly, the term “milliampere-hour (mAh)” also refers to a unit of the storage capacity of a battery and is 1/1,000 of an Ampere-hour. The capacity of a battery (and an anode in particular) may be determined by methods known in the art, for example including, but not limited to: applying a fixed constant current load to a fully charged cell until the cell's voltage reaches the end of discharge voltage value; the time to reach end of discharge voltage multiplied by the constant current is the discharge capacity; by dividing the discharge capacity by the weight of electrode material or volume. Within the context of the present disclosure, measurements of capacity are acquired according to this method, unless otherwise stated. Unless otherwise noted, capacity is reported at cycle 10 of the battery.

As used herein, the term “electrode” refers to a “cathode” or an “anode.” As used herein, the term “positive electrode” is used interchangeably with cathode. Likewise, the term “negative electrode” is used interchangeably with anode.

Within the context of the present disclosure, the term “dispersion” refers to a dispersion in which one substance, which is the dispersed phase, is distributed in discrete units throughout the second substance (continuous phase or medium). In general, the dispersed phase is not substantially agglomerated, but rather spaced within the second substance. While dispersion includes the gathering or touching of a few particles (e.g., two, three, four, less than five), the particles are generally spaced evenly throughout the second substance.

Within the context of the present disclosure, the terms “framework” or “framework structure” refer to the network of interconnected oligomers, polymers, or colloidal particles that form the solid structure of a gel or an aerogel. The polymers or particles that make up the framework structures typically have a diameter of about 100 Angstroms. However, framework structures of the present disclosure can also include networks of interconnected oligomers, polymers, or colloidal particles of all diameter sizes that form the solid structure within a gel or aerogel.

Within the context of the present disclosure, the term “pore size distribution” refers to the statistical distribution or relative amount of each pore size within a sample volume of a porous material. A narrower pore size distribution refers to a relatively large proportion of pores at a narrow range of pore sizes, thus optimizing the amount of pores that can surround the electrochemically active species and maximizing use of the pore volume. Conversely, a broader pore size distribution refers to relatively small proportion of pores at a narrow range of pore sizes. As such, pore size distribution is typically measured as a function of pore volume and recorded as a unit size of a full width at half max of a predominant peak in a pore size distribution chart. The pore size distribution of a porous material may be determined by methods known in the art, for example including, but not limited to, surface area and porosity analyzer by nitrogen adsorption and desorption from which pore size distribution can be calculated. Within the context of the present disclosure, measurements of pore size distribution are acquired according to this method, unless otherwise stated. In certain aspects, aerogel materials (e.g., carbon-based aerogel materials) may have a relatively narrow pore size distribution (full width at half max) of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values.

Within the context of the present disclosure, the term “pore volume” refers to the total volume of pores within a sample of porous material. The total volume of pores includes the total volume of micropores, total volume of mesopores and the total volume of macropores. As used herein the term “micropores” refers to pores having a width less than 3 nm. As used herein, the term “mesopores” refers to pores having a width of 3 nm up to 50 nm. As used herein, the term macropores refers to pores having a width of greater than 50 nm. Pore volume is specifically measured as the volume of void space within the porous material, where that void space may be measurable and/or may be accessible by another material, for example an electrochemically active species such as silicon particles. Pore volume is typically recorded as cubic centimeters per gram (cm³/g or cc/g).

The pore volume of a porous material may be determined by methods known in the art, for example including, but not limited to, surface area and porosity analyzer by nitrogen adsorption and desorption from which pore volume can be calculated. Within the context of the present disclosure, measurements of pore volume are acquired according to this method, unless otherwise stated. In certain aspects, aerogel materials (e.g., carbon-based aerogel materials) without incorporation of electrochemically active species, e.g., silicon, have a relatively large pore volume of about 1 cc/g or more, 1.5 cc/g or more, 2 cc/g or more, 2.5 cc/g or more, 3 cc/g or more, 3.5 cc/g or more, 4 cc/g or more, or in a range between any two of these values. In other aspects, aerogel materials (e.g., carbon-based aerogel materials) or composite materials (with incorporation of electrochemically active species, e.g., silicon) have a pore volume of about 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values.

Within the context of the present disclosure, the term “porosity” when used with respect to the porous network or the composite materials disclosed herein, refers to a volumetric ratio of pores that does not contain another material (e.g., an electrochemically active species such as silicon particles) bonded to the walls of the pores. For clarification and illustration purposes, it should be noted that within the specific implementation of silicon-doped porous network e.g., an aerogel as the primary anodic material in a LIB, porosity refers to the void space after inclusion of silicon particles. As such, porosity may be, for example, about 10%-70% when the anode is in a pre-lithiated state (to accommodate for ion transport and silicon expansion) and about 1%-50% when the anode is in a post-lithiated state (to accommodate for ion transport). More generally, porosity may be determined by methods known in the art, for example including, but not limited to, the ratio of the pore volume of the aerogel material to its bulk density. Within the context of the present disclosure, measurements of porosity are acquired according to this method, unless otherwise stated. In certain aspects, aerogel materials e.g., carbon aerogel materials (carbon-based aerogel materials) or composite materials of the present disclosure have a porosity of about 80% or less, 70% or less, 60% or less, 50% or less, 40% or less, 30% or less, 20% or less, 10% or less, or in a range between any two of these values.

It should be noted that pore volume and porosity are different measures for the same property of the pore structure, namely the “empty space” within the pore structure. For example, when silicon is used as the electrochemically active species contained within the pores of the porous network (e.g., a composite material as described herein), pore volume and porosity refer to the space that is “empty”, namely the space not utilized by the silicon or the carbon.

Within the context of the present disclosure, the term “pore size at max peak from distribution” refers to the value at the discernible peak on a graph illustrating pore size distribution. Pore size at max peak from distribution is specifically measured as the pore size at which the greatest percentage of pores is formed. It is typically recorded as any unit length of pore size, for example micrometers or nanometers (nm). The pore size at max peak from distribution may be determined by methods known in the art, for example including, but not limited to, surface area and porosity analyzer by nitrogen adsorption and desorption from which pore size distribution can be calculated and pore size at max peak can be determined. Within the context of the present disclosure, measurements of pore size at max peak from distribution are acquired according to this method, unless otherwise stated. In some aspects, aerogel materials e.g. carbon-based xerogel materials or composite materials of the present disclosure have a pore size at max peak from distribution of over about 50 nm, between about 3 nm to about 50 nm, or less than 3 nm. In certain aspects, aerogel materials e.g. carbon-based aerogel materials or composite materials of the present disclosure have a pore size at max peak from distribution of about 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, 30 nm or less, 20 nm or less, 10 nm or less, 5 nm or less, 2 nm or less, or in a range between any two of these values.

Within the context of the present disclosure, the term “BET surface area” has its usual meaning of referring to the Brunauer-Emmett-Teller method for determining surface area by N₂ adsorption measurements. The BET surface area, expressed in m²/g, is a measure of the total surface area of a porous material per unit of mass. Unless otherwise stated, “surface area” refers to BET surface area. As an alternative to BET surface area, a geometric outer surface area of e.g., a polyimide or carbon bead may be calculated based on the diameter of the bead. Generally, such geometric outer surface areas for beads of the present disclosure are within a range from about 3 to about 700 μm².

Within the context of the present disclosure, the term “pyrolyze” or “pyrolysis” or “carbonization” refers to the decomposition or transformation of an organic compound or composition to pure or substantially pure carbon caused by heat. In the examples, the term “carbonization yield” refers to a percentage ratio of the weight of the resultant carbon to the weight of the organic compound or composition from which the carbon is produced.

As used herein, the term “particle size distribution D50” refers to a volume-based accumulative 50% size which is a particle size at a point of 50% on an accumulative curve (i.e., a diameter of a particle in the 50th percentile (median) of the volumes of particles) when the accumulative curve is drawn so that a particle size distribution is obtained on the volume basis and the whole volume is 100%.

Within the context of the present disclosure, the term “density” refers to a measurement of the mass per unit volume of a material (e.g., a composite material as described herein). The term “density” generally refers to the true or skeletal density of a material, as well as to the bulk density of a material or composition. Density is typically reported as kg/m³ or g/cm³. The density of an material or composite material may be determined by methods known in the art, including, but not limited to: Standard Test Method for Dimensions and Density of Preformed Block and Board-Type Thermal Insulation (ASTM C303, ASTM International, West Conshohocken, Pa.); Standard Test Methods for Thickness and Density of Blanket or Batt Thermal Insulations (ASTM C167, ASTM International, West Conshohocken, Pa.); or Determination of the apparent density of preformed pipe insulation (ISO 18098, International Organization for Standardization, Switzerland).

Preferably, aerogel materials (e.g., carbon-based aerogel materials) or composite materials of the present disclosure have a tap density of about 1.50 g/cc or less, about 1.40 g/cc or less, about 1.30 g/cc or less, about 1.20 g/cc or less, about 1.10 g/cc or less, about 1.00 g/cc or less, about 0.90 g/cc or less, about 0.80 g/cc or less, about 0.70 g/cc or less, about 0.60 g/cc or less, about 0.50 g/cc or less, about 0.40 g/cc or less, about 0.30 g/cc or less, about 0.20 g/cc or less, about 0.10 g/cc or less, or in a range between any two of these values, for example from about 0.15 g/cc to about 1.5 g/cc, or more particularly from about 0.50 g/cc to about 1.30 g/cc.

Preferably, aerogel materials (e.g., carbon-based aerogel materials) or composite materials of the present disclosure have a helium skeletal density in a range from about 1.5 to about 2.5/cc, for example from about

Preferably, aerogel materials (e.g., carbon-based aerogel materials) or composite materials of the present disclosure have a mercury skeletal density from about 1.0 to about 2.3/cc, for example from about

Preferably, aerogel materials (e.g., carbon-based aerogel materials) or composite materials of the present disclosure have a bulk density from about 0.5 to about 2.0/cc, for example from about

### Composite Materials

In one aspect, the composite materials provided herein deliver high lithium storage capacity with improved cyclability.

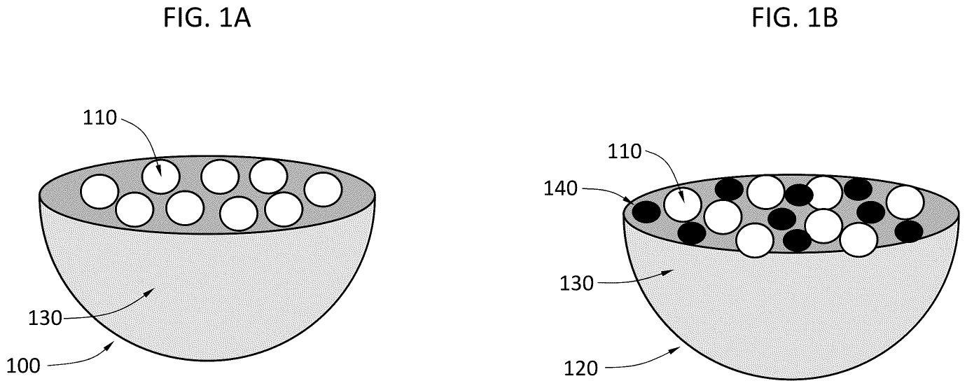

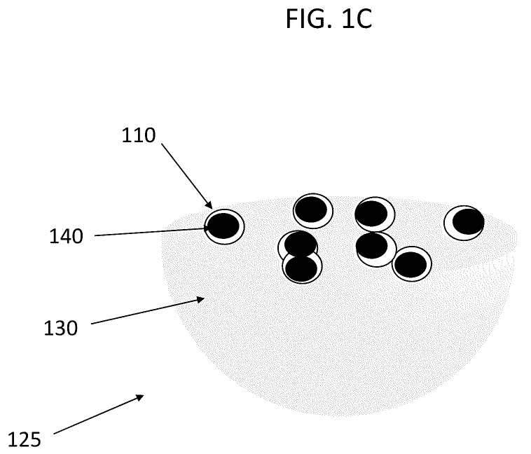

FIG. 1A and FIG. 1B illustrate an exemplary composite material of the present disclosure comprising macropores. Referring to FIG. 1A, in one aspect provided herein is a composite material 100 comprising micropores 110 or mesopores 112 (not shown), and a three-dimensional carbon network 130. The three-dimensional carbon network 130 may include a carbon aerogel, a carbon xerogel, a carbon ambigel, a carbon aerogel-xerogel hybrid material, a carbon aerogel-ambigel hybrid material, a carbon aerogel-ambigel-xerogel hybrid material, or combinations thereof.

Referring to FIG. 1B, in one aspect provided herein is a composite material 120 comprising macropores 110, the composite material further comprising a three-dimensional carbon network 130; and silicon particles 140, wherein the silicon particles 140 are dispersed throughout the three-dimensional carbon network 130 and at least some of the macropores 110 are formed by carbonizing a plurality of sacrificial particles 160 (not shown) dispersed throughout a three-dimensional network 130. The macropores may at least partially surround or encompass the silicon particles, and as a result are able to accommodate volumetric changes in the silicon particles.

Referring to FIG. 1C, in one aspect provided herein is a composite material 125 comprising silicon particles 140 disposed at least partially in macropores 110. At least some of the silicon particles 140 disposed or partially disposed in macropores are formed by carbonizing sacrificial particles 160 (not shown) formed around the silicon particles 140. The composite material may further comprise a three-dimensional carbon network 130, wherein the macropores 110 and the silicon particles 140 therein are dispersed throughout the three-dimensional network 130. In some aspects, the silicon is contained at least partially within the micropores and/or mesopores of the three-dimensional carbon network 130, i.e., the silicon is disposed within the framework of the network. In some aspects, the silicon is disposed within the pores (e.g., the macropores 110) in the three-dimensional carbon network 130. The silicon accepts lithium ions during charge and releases lithium ions during discharge. In certain aspects, the three-dimensional carbon network 130 forms interconnected structures around the silicon, which is connected to the network at a plurality of points. In some aspects, the three-dimensional network is a porous network.

In some aspects, the three-dimensional network 130 comprises an aerogel, a xerogel, an ambigel, an aerogel-xerogel hybrid material, an aerogel-ambigel hybrid material, an aerogel-ambigel-xerogel hybrid material, or combinations thereof. In some aspects, the three-dimensional network 130 is in the form of a bead. In some aspects, the bead is substantially spherical, having a diameter from about 100 nm to about 4 mm, or from about 0.5 μm to about 15 μm, or from about 1 μm to about 10 μm, or from about 5 μm to about 4 mm.

Within the context of the present disclosure, the term “macropores” refer to pores with a diameter greater than about 50 nm. For example, pores between about 50 nm to about 10 μm, pores between about 50 nm to about 10 μm, or pores between about 500 nm to about 5 μm in the composite material formed from carbonizing sacrificial materials. The space occupied by the macropores refer to the space that is “empty”, namely the space not utilized by the either silicon or the three-dimensional carbon network. The macropores surround or encompass the silicon particles providing separation or space to accommodate “breathing” of the silicon. At least some of the macropores of the composite material disclosed herein are formed by carbonizing a plurality of sacrificial particles dispersed throughout a three-dimensional network 130 or around the silicon particles 140. The three-dimensional carbon network and/or the three-dimensional network of the present disclosure may also include micropores and/or mesopores.

Within the context of the present disclosure, the term “micropores” refer to pores with a diameter smaller than 3 nm, the term “mesopores” refers to pores with a diameter between 3 nm and 50 nm, and the term “macropores” refer to pores with a diameter greater than 50 nm.

In a particular aspect, the composite materials according to certain aspects of the present technology possess a bimodal pore size distribution comprised of a first mode of pores and a second mode of pores. Preferably, the first mode of pores has a mean pore diameter ranging from about 50 nm to about 1000 nm and the second mode of pores has a mean pore diameter ranging from about 100 nm to about 10 μm.

In a particular aspect, the composite materials according to certain aspects of the present technology possesses a multimodal pore size distribution comprised of a first mode of pores, a second mode of pores, and a third mode of pores. Preferably, the first mode of pores has a mean pore diameter greater than 50 nm, the second mode of pores has a mean pore diameter ranging from about 3 nm to about 50 nm and the third mode of pores has a mean pore diameter less than 3 nm.

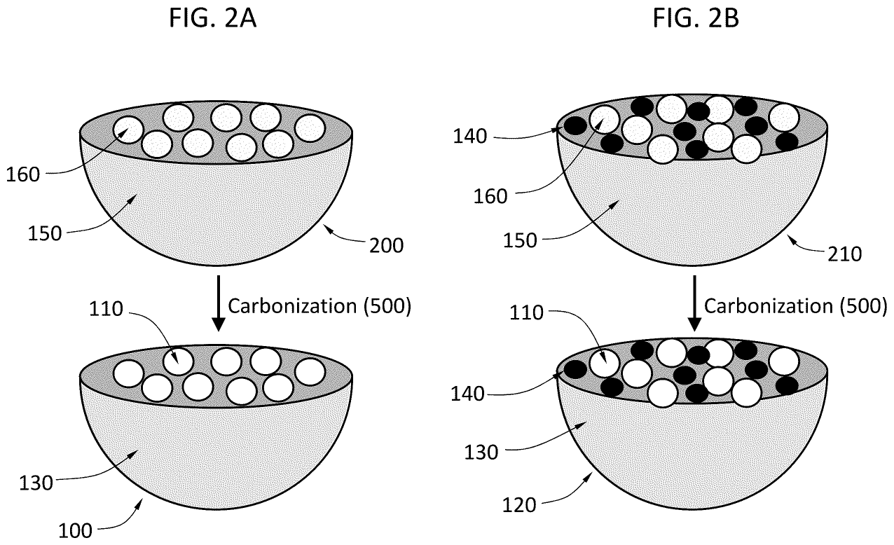

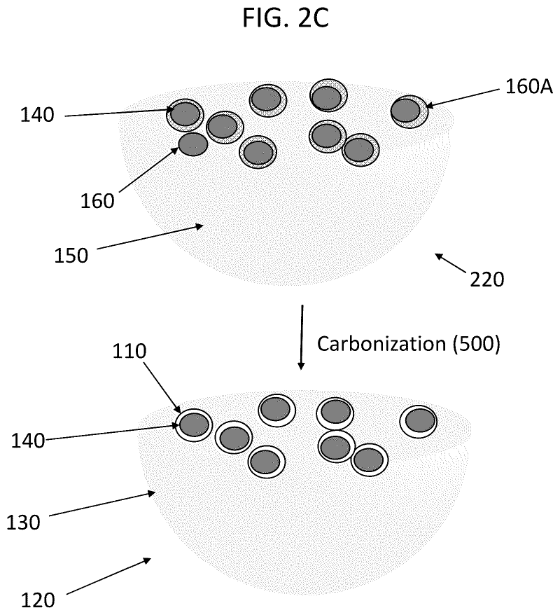

FIG. 2A and FIG. 2B illustrate exemplary composite materials (200, 210, respectively) according to certain aspects of the present technology and a method 500 of treating the composite materials to obtain composite materials comprising macropores. Referring to FIG. 2A, the composite material 200 comprises a three-dimensional network 150 and sacrificial particles 160, wherein the sacrificial particles 160 are dispersed throughout the three-dimensional network 150.

In some aspects, the composite material of the present technology (110, 120, 200, 210) is in monolithic form, in the form of thin sheets, or in particulate form.

The sacrificial particles are typically provided from the same source and have a known, desired particle size, shape, porosity and other material attributes that are substantially similar. In some examples, the sacrificial particles have a diameter of less than about 15 μm, about 10 μm, about 8 μm, about 5 μm, about 2 μm, less than about 1000 nm, less than about 800 nm, less than about 500 nm, less than about 300 nm, less than about 250 nm, less than about 200 nm, less than about 150 nm or less than about 100 nm.

Referring to FIG. 2B, the composite material 210 comprises a three-dimensional network 150; sacrificial particles 160 and silicon particles 140, wherein the sacrificial particles 160 and the silicon particles 140 are dispersed throughout the three-dimensional network 150.

Referring to FIG. 2C, the composite material 220 comprises a three-dimensional network 150, sacrificial materials 160 and silicon particles 140, wherein the silicon particles 140 each includes a coating layer 160A made of sacrificial materials 160. The silicon particles 140 with coating layer 160A are dispersed throughout the three-dimensional network 150. In some examples, the silicon particles 140 have a diameter of less than about 10 μm, less than about 8 μm, less than about 5 μm, less than about 3 μm, less than about 2 μm, less than about 1000 nm, less than about 800 nm, less than about 500 nm, less than about 300 nm, less than about 250 nm, less than about 200 nm, less than about 150 nm or less than about 100 nm.

In order to obtain the composite materials (100, 120, and 125) according to some aspects of this technology, the composite materials (200, 210, or 220) provided herein comprising sacrificial particles undergo pyrolysis (i.e., carbonization) 500. The sacrificial particles 160 may comprise poly(styrene), poly(ester), poly(methacrylate), poly(acrylate), poly(ethylene glycol), poly(acid amides), poly(norborene), or combination thereof. In one aspect, the sacrificial particles comprise poly(methyl methacrylate). The sacrificial particles may not be substantially spherical. In some examples, the sacrificial particles may be substantially spherical

In some aspects, the sacrificial particles and/or the sacrificial layers have a carbonization 500 yield of less than about 20 wt %. In some aspects, the temperature of chemical decomposition of the sacrificial particles is in the range of about 130° C. to about 850° C. The sacrificial particles can be made of polymers, metals, natural and synthetic organics, salts, ceramic compounds or combinations thereof.

In some aspects, the composite material of the present disclosure comprises a low bulk density material such as carbon-aerogels. In some aspects, the low bulk density material comprises a skeletal framework comprising nanofibers, the skeletal framework forming a pore structure comprising an array of interconnected pores. In some aspects, such materials may have a fibrillar morphology. In some aspects, the composite material is a carbon aerogel, a carbon xerogel, a carbon cryogel, or a carbon ambigel, or combination thereof. In some aspects, the composite material is an aerogel. In contrast to an aerogel, a xerogel, such as a silica xerogel, generally comprises a compact structure. Xerogels experience substantial volume reduction during ambient pressure drying, and can have lower surface areas compared to aerogels, such as 0-100 m²/g, or from about 0 to about 20 m²/g as measured by nitrogen sorption analysis. In addition, xerogels have a more densely packed fibrillar morphology compared to aerogels. Within the context of the present disclosure, the term “fibrillar morphology” refers to the structural morphology of a nanoporous material (e.g., a carbon aerogel) being inclusive of struts, rods, fibers, or filaments. Structurally, some aspects of the carbon network have a fibrillar morphology with a strut size that produces the aforementioned narrow pore size distribution, porosity, and enhanced connectedness, among other properties. In any aspect, the fibrillar morphology of the carbon network can include an average strut width of about 2-10 nm, or even more specifically about 2-5 nm.

Within the context of the present disclosure, the term “strut width” refers to the average diameter of nanostruts, nanorods, nanofibers, or nanofilaments that form a material having a fibrillar morphology. It is typically recorded as any unit length, for example micrometers or nm. The strut width may be determined by methods known in the art, for example including, but not limited to, scanning electron microscopy image analysis. Within the context of the present disclosure, measurements of strut width are acquired according to this method, unless otherwise stated. In certain aspects, materials or compositions of the present disclosure have a strut width of about 10 nm or less, 9 nm or less, 8 nm or less, 7 nm or less, 6 nm or less, 5 nm or less, 4 nm or less, 3 nm or less, 2 nm or less, or in a range between any two of these values. An exemplary range of strut widths is about 2-5 nm. Smaller strut widths, such as these, permit a greater amount of struts to be present within the network and thus contact the electrochemically active species, in turn allowing more of the electrochemically active species to be present within the composite. This increases electrical conductivity and mechanical strength.

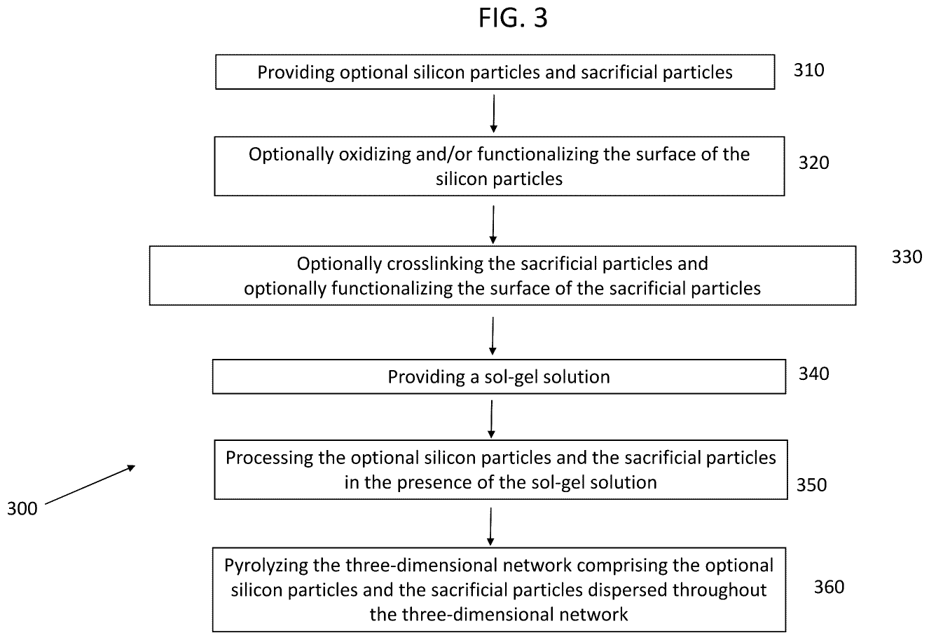

Referring to FIG. 3, method 300 illustrating the manufacture of a composite material according to multiple aspects of the present disclosure includes six steps (310, 320, 330, 340, 350, 360). In this method 300, at least some of the macropores are formed after pyrolyzing a three-dimensional network comprising optional silicon particles and sacrificial particles.

First, as shown in step 310, optional silicon particles and sacrificial particles are provided. In general, the silicon particles should be homogenous. That is, the silicon particles are typically provided from the same source and have a known, desired particle size, shape, porosity and other material attributes that are substantially similar. The sacrificial particles have been described above.

After the providing the silicon particles (310), the method 300 optionally includes oxidizing and/or functionalizing the surface of the particles in step 320. One of the purposes of the oxidizing and/or functionalizing the surface of the particles is to increase hydrophilicity of the silicon particles (i.e., step 320). Oxidizing the surface of silicon particles may lead to complete or partial oxidation of surface Si—H groups. That is, all or certain percentage of Si—H groups on the surface of the silicon particles are converted to Si—OH groups after oxidation process. The silicon particles may be oxidized in a single or multiple step(s). The oxidation can be thermal (e.g. at elevated temperatures under air), chemical (e.g. acid and/or oxidizing agent), electrochemical or combinations thereof. Functionalizing the surface of the silicon particles may use hydroxyl functional groups on the surface of the silicon particles. The hydroxyl functional groups are allowed to covalently react with at least one functional silane group. Attachment of silane groups to the surface can pave the way for further modification of the silicon particles' surfaces. In addition, silane groups present on the surface of the silicon particles can aid the dispersion of the silicon particles which is crucial for further steps. The silicon particles may be functionalized with functional groups formed from molecules selected from 3-aminopropyltriethoxysilane (APTES), 3-aminopropyltrimethoxysilane (APTMS), N-(2-aminoethyl)-3-aminopropyltriethoxysilane (AEAPTES), and N-(2-aminoethyl)-3-aminopropyltrimethoxysilane (AEAPTMS), and N-(6-aminohexyl)aminomethyltriethoxysilane (AHAMTES), or combination thereof.

In step 330, the sacrificial particles provided in step 310 may be optionally crosslinked to a cross-linking agent and optionally functionalized with a polymer modifier (e.g., hydrophilic moiety). A polymer modifier may help to increase hydrophilicity of the sacrificial particles.

In step 340, a sol-gel solution is provided. The silicon particles, sacrificial particles and/or sacrificial material coated silicon particles may be dispersed in the provided sol-gel solution homogeneously or heterogeneously. In some aspects, the particles are provided homogenously. The sol-gel solution may include a polar solvent and a precursor of a three-dimensional network. A precursor of the porous three-dimensional network may be a precursor of an aerogel precursor, a xerogel precursor, an ambigel precursor, an aerogel-xerogel hybrid material precursor, an aerogel-ambigel hybrid material precursor, an aerogel-ambigel-xerogel hybrid material precursor, or combinations thereof. The polar solvent may include dimethylsulfoxide (DMSO), dimethylformamide (DMF), ethyl acetate, n-methyl pyrrolidone (NMP), dimethylacetamide (DMA), propylene carbonate, water, glycerin, propylene glycol, ethylene glycol, tetraethylene glycol, triethylene glycol and trimethylene glycol, or mixtures thereof. The selected polar solvent should be suitable for dissolving or suspending each component, e.g., the polymer (initiator) (e.g., a precursor of three-dimensional network), the silicon particles, of the reaction.

Step 350 includes forming a composite material comprising: a three-dimensional network; sacrificial particles dispersed throughout the three-dimensional network; silicon particles dispersed throughout the three-dimensional network; and/or sacrificial material coated silicon particles dispersed throughout the three-dimensional network.

The processing in Step 350 may include mixing the sol-gel solution with non-immersible liquids (e.g., mineral oil, mineral spirits, and/or other liquid not immersible with the sol-gel solution) to form an emulsion of sol-gel solution droplets in the non-immersible liquids. The sol-gel solution droplets each includes silicon particles, sacrificial particles, and/or sacrificial material coated silicon particles wrapped around by the sol-gel solution. The sol-gel solution droplets are subsequently separated from the non-immersible liquids and optionally washed to remove the residual non-immersible liquids on the surface of the droplets. The precursor of the three-dimensional network in the sol-gel solution forms the three-dimensional network in the droplets. The method further includes a step of subcritical drying, supercritical drying, spray drying, or ambient pressure drying of the sol-gel solution droplets to form the three-dimensional porous network with the silicon particle, the sacrificial particle, and/or the sacrificial material coated silicon particle disposed therein. The three-dimensional network may be an aerogel, an xerogel, or hybrid thereof.

The processing in step 350 may alternatively include directly forming the three-dimensional network with the silicon particles, sacrificial particles, and/or sacrificial material coated silicon particles dispersed therein without the emulsification process in a non-immersible liquid. For example, the sol-gel solution with the silicon particles, sacrificial particles, and/or sacrificial material coated silicon particles dispersed therein may be directly dried by a spray dryer or by an oven under agitation. During the drying process, the precursor of the three-dimensional network in the sol-gel solution forms the three-dimensional network wrapping around the silicon particles, sacrificial particles, and/or sacrificial material coated silicon particles.

Step 360 includes pyrolyzing the three-dimensional network to form the carbonized three-dimensional network comprising the optional silicon particles, the sacrificial particles, and/or the sacrificial material coated silicon particles dispersed throughout the three-dimensional network to form a composite particle that includes macropores. At least some of the macropores may be formed due to removing of the sacrificial particles during the pyrolyzing process. In one aspect, an amount of sacrificial particles that is removed depends on the duration of heat treatment, e.g., pyrolysis, applied to the porous network. In some aspects, the pore size of macropores depends on the amount of sacrificial particles that is removed by the pyrolyzing process. For example, pyrolyzing process at higher temperature and/or longer duration may result in larger pore sizes of macropores than the macropores formed by the pyrolyzing process at lower temperature and/or shorter period of time.

In some aspects, the chemical decomposition temperature of the sacrificial particles is in the range of about 130° C. to about 850° C. In certain aspects, processing the composite material to partially or completely remove the sacrificial particles provides a void space (e.g., macropores) adjacent to or around the silicon particles.

In some aspects, the method of preparing a composite material further comprises a step of subcritical or supercritical drying after processing the sol-gel solution. In some aspects, the step of subcritical or supercritical drying results in formation of aerogel materials e.g. xerogels, aerogels etc.

Oxidizing the surface of the silicon particles may comprise an acid treatment step. In some aspects, the acid treatment step comprises the use of sulphochromic acid or H₂O₂ (hydrogen peroxide). In some examples, the acid treatment step comprises a step of sonicating the plurality of the silicon particles for a certain period of time, e.g., at least 5 minutes, at least 10 minutes, at least 20 minutes, at least 30 minutes, or at least 60 minutes. Oxidizing a surface of the plurality of the silicon particles may comprise a step of pyrolysis at a temperature about at 300° C., about 400° C., or about 500° C., to about 600° C., about 650° C., about 700° C., about 800° C., about 850° C., or about 900° C. In some aspects, the temperature is about 650° C. As used herein, the term “pyrolyze” or “pyrolysis” refers to the decomposition or transformation of an organic compound or composition to pure or substantially pure carbon caused by heat. Oxidizing a surface of the plurality of the silicon particles may lead to a decrease in the number of Si—H bonds on the surface of the silicon particles.

In some aspects, the method of preparing a composite material of the present disclosure further comprises a step of subcritical or supercritical solvent removal, e.g., drying, after processing the plurality of silicon particles in the presence of the sol-gel solution (prior to or after pyrolysis step). Methods of solvent removal include, but are not limited to, supercritical drying (or drying using supercritical fluids, such that the low surface tension of the supercritical fluid exchanges with the transient solvent within the gel), exchange of solvent with supercritical fluid, exchange of solvent with fluid that is subsequently transformed to the supercritical state, sub- or near-critical fluid drying, and sublimating a frozen solvent in a freeze-drying process. See for example, PCT Patent Application Publication No. WO2016127084A1.

The composite material may be in a variety of different physical forms. In some aspects, the composite material can take the form of a monolith. As used herein, the term “monolith” refers to materials in which a majority (by weight) of the low-density skeletal framework included in the composite material is in the form of a unitary, continuous, self-supporting object. With reference to aerogel materials, monolithic aerogel materials include aerogel materials which are initially formed to have a well-defined shape, but which can be subsequently cracked, fractured or segmented into non-self-repeating objects. For example, irregular chunks may be considered as monoliths. Monolithic aerogels may take the form of a freestanding structure, or a reinforced material with fibers or an interpenetrating foam.

In other aspects, the composite material may be in particulate form, for example as beads or as particles from, e.g., crushing a monolithic material. As used herein, the term “beads” is meant to include discrete small units or pieces having a generally spherical shape. In some aspects, the composite material beads are substantially spherical.

The composite material in particulate form can have various particle sizes. In the case of spherical particles (e.g., beads), the particle size is the diameter of the particle. In the case of irregular particles, the term particle size refers to the maximum dimension (e.g., a length, width, or height). The particle size may vary depending on the physical form, preparation method, and any subsequent physical steps performed. In some aspects, the composite material in particulate form can have a particle size from about 1 micrometer to about 1 millimeter. For example, the composite material in particulate form can have a particle size of about 1 micrometer, about 2 micrometers, about 3 micrometers, about 4 micrometers, about 5 micrometers, about 6 micrometers, about 7 micrometers, about 8 micrometers, about 9 micrometers, about 10 micrometers, about 15 micrometers, about 20 micrometers, about 25 micrometers, about 30 micrometers, about 35 micrometers, about 40 micrometers, about 45 micrometers, about 50 micrometers, about 60 micrometers, about 70 micrometers, about 80 micrometers, about 90 micrometers, about 100 micrometers, about 200 micrometers, about 300 micrometers, about 400 micrometers, about 500 micrometers, about 600 micrometers, about 700 micrometers, about 800 micrometers, about 900 micrometers, about 1 millimeter, or in a range between any two of these values.

In some aspects, the composite material has a particle size D90 value of less than or equal to 40 micrometers. In some aspects, the composite material has a particle size D10 value of at least 1 micrometer. In some aspects, the composite material has a particle size distribution D50 in a range from about 5 micrometers to about 20 micrometers.

The density of the composite material may vary. In some aspects, the composite material has a tap density in a range from about 0.15 g/cm³ to about 1.2 g/cm³.

The surface area of the composite material may vary. For example, the surface area may be up to about 100 m²/g, or may be greater than 100 m²/g. In some aspects, the composite material has a surface area in a range from about 0.05 m²/g to about 400 m²/g. In some aspects, the composite material can have a surface area of at least about 0.1 m²/g to about 10 m²/g, about 1 m²/g to about 25 m²/g, about 1 m²/g to about 50 m²/g, about 1 m²/g to about 1 m²/g, or about 1 m²/g to about 300 m²/g.

In some aspects, the composite material comprises silicon in an amount by weight from about 1% to about 85%, such as from about 2%, from about 5% from about 10%, from about 15%, about 20%, about 25%, about 30%, about 35%, about 40%, about 45%, or about 50%, to about 55%, about 60%, about 65%, about 70%, about 75%, about 80%, or about 85% silicon by weight, based on the total weight of the composite material.

In other aspects, the composite material may be in particulate form, for example as beads or as particles from, e.g., crushing a monolithic material. As used herein, the term “beads” is meant to include discrete small units or pieces having a generally spherical shape. In some aspects, the carbon-silicon composite beads are substantially spherical.

The capacity of the composite material may vary. In some aspects, the composite material has a specific capacity of at least about 400 mAh/g. In some aspects, the composite material has a specific capacity of about 400 mAh/g, about 500 mAh/g, about 600 mAh/g, about 700 mAh/g, about 800 mAh/g, about 900 mAh/g, about 1000 mAh/g, or about 1100 mAh/g. In some aspects, the composite material has a specific capacity of 1200 mAh/g or more, 1400 mAh/g or more, 1600 mAh/g or more, 1800 mAh/g or more, 2000 mAh/g or more, 2400 mAh/g or more, 2800 mAh/g or more, 3200 mAh/g or more, or in a range between any two of these values.

The electrical conductivity of the anode material may vary. Within the context of the present disclosure, the term “electrical conductivity” refers to a measurement of the ability of a material to conduct an electric current or other allow the flow of electrons there through or therein. Electrical conductivity is specifically measured as the electric conductance/susceptance/admittance of a material per unit size of the material. It is typically recorded as S/m (Siemens/meter) or S/cm (Siemens/centimeter). The electrical conductivity or resistivity of a material may be determined by methods known in the art, for example including, but not limited to: In-line Four Point Resistivity (using the Dual Configuration test method of ASTM F84-99). Within the context of the present disclosure, measurements of electrical conductivity are acquired according to ASTM F84-resistivity (R) measurements obtained by measuring voltage (V) divided by current (I), unless otherwise stated. In certain aspects, anode materials of the present disclosure have an electrical conductivity of about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

### The Three-Dimensional Carbon Network

The three-dimensional carbon network of the present disclosure comprises a carbon-based network selected from a carbon aerogel, a carbon xerogel, a carbon ambigel, a carbon aerogel-xerogel hybrid material, a carbon aerogel-ambigel hybrid material, a carbon aerogel-ambigel-xerogel hybrid material, or combinations thereof. The three-dimensional carbon network of the present disclosure is also referred to as aerogel, aerogels, carbon aerogel, carbon aerogels, or carbon aerogel beads.

The aerogels used in the present disclosure may be carbonized to obtain the three-dimensional carbon network e.g., carbon-based aerogel of this present technology. Carbonization may be carried out by pyrolysis at elevated temperatures in an inert atmosphere. The carbonized forms of the aerogels used in the present disclosure may have the nitrogen content between 0 and 20%. Typical pyrolysis temperatures range is between 500° C. and 2000° C. Temperature may be increased to reduce the nitrogen content of the resulting carbon aerogel. Pyrolysis is typically carried out in an inert atmosphere (i.e. nitrogen, helium, neon, argon or some combination).

In some aspects, the three-dimensional carbon network comprises a polyimide-derived carbon aerogel or carbon xerogel. In some aspects, the dried polyimide aerogel is subjected to a treatment temperature of 300° C. or above, 400° C. or above, 600° C. or above, 800° C. or above, 1000° C. or above, 1200° C. or above, 1400° C. or above, 1600° C. or above, 1800° C. or above, 2000° C. or above, 2200° C. or above, 2400° C. or above, 2600° C. or above, 2800° C. or above, or in a range between any two of these values, for carbonization of the polyimide aerogel to obtain a polyimide-derived carbon aerogel.

The present disclosure involves the formation and use of three-dimensional carbon network, such as carbon aerogels, as electrode materials within an energy storage device, for example as the primary anodic material in a LIB. The pores of the porous network are designed, organized, and structured to accommodate particles of silicon or other metalloid or metal, and expansion of such particles upon lithiation in LIB, for example. Alternatively, the pores of the porous network may be filled with sulfide, hydride, any suitable polymer, or other additive where there is a benefit to contacting the additive with an electrically conductive material to provide for a more effective electrode.

To further expand on the exemplary application within LIBs, when carbon-based aerogel material is used as the primary electrode material (e.g., anodic material) as in examples of this present disclosure, the carbon aerogel porous core has a narrow pore size distribution, and provides for high electrical conductivity, high mechanical strength, and a morphology and sufficient pore volume (at a final density) to accommodate a high percentage by weight of silicon particles and expansion thereof.

In some examples, the surface of the three-dimensional carbon network may be modified via chemical, physical, or mechanical methods in order to enhance performance with electrochemically active species contained within the pores of the porous network.

Furthermore, it is contemplated herein that the three-dimensional carbon network, and specifically carbon aerogels, can take the form of monolithic structures. When monolithic in nature, the carbon aerogel eliminates the need for any binders; in other words, the anode can be binder-less. As used herein, the term “monolithic” refers to aerogel materials in which a majority (by weight) of the aerogel included in the aerogel material or composition is in the form of a unitary, continuous, interconnected aerogel nanostructure. Monolithic carbon aerogel materials include carbon aerogel materials which are initially formed to have a unitary interconnected gel or aerogel nanostructure, but which can be subsequently cracked, fractured or segmented into non-unitary aerogel nanostructures. Monolithic aerogels may take the form of a freestanding structure or a reinforced (fiber or foam) material. In comparison, using silicon lithiation as an example, silicon incorporated into a monolithic aerogel can be utilized more effectively relative to theoretical capacity, as compared to the same amount of silicon incorporated into a slurry using conventional processes.

Monolithic aerogel materials (e.g., monolithic carbon aerogels) are differentiated from particulate aerogel materials. The term “particulate aerogel material” refers to aerogel materials in which a majority (by weight) of the aerogel included in the aerogel material is in the form of particulates, particles, granules, beads, or powders, which can be combined together (i.e., via a binder, such as a polymer binder) or compressed together but which lack an interconnected aerogel nanostructure between individual particles. Collectively, aerogel materials of this form will be referred to as having a powder or particulate form (as opposed to a monolithic form). It should be noted that despite an individual particle of a powder having a unitary structure, the individual particle is not considered herein as a monolith. Integration of aerogel powder into an electrochemical cell typically preparation of a paste or slurry from the powder, casting and drying onto a substrate, and may optionally include calendaring.

Particulate aerogel materials, e.g., carbon aerogel beads, provide certain advantages. For example, particulate materials can be used as a direct replacement for other materials such as graphite in LIB anodes and anode manufacturing processes. Particulate materials can also provide improved lithium-ion diffusion rates due to shorter diffusion paths within the particulate material. Particulate materials can also allow for electrodes with enhanced packing densities, e.g., by tuning the particle size and packing arrangement. Particulate materials can also provide improved access to silicon due to inter-particle and intra-particle porosity.

Carbon aerogels can be formed from inorganic materials, organic materials, or mixtures thereof. Carbon aerogels can be formed from inorganic aerogels, organic aerogels, or mixtures thereof. Inorganic aerogels, organic aerogels, or mixtures thereof may be carbonized to obtain the three-dimensional carbon network (e.g., porous carbon aerogels) of the present disclosure. Aerogels can be formed of inorganic materials, organic materials, or mixtures thereof. When formed of organic materials such as, for example, phenols, resorcinol-formaldehyde (RF), phloroglucinol-furfuraldehyde (PF), polyacrylonitrile (PAN), polyimide (PI), polyurethane (PU), polyurea (PUA), polyamine (PA), polybutadiene, polydicyclopentadiene, and precursors or polymeric derivatives thereof, the organic aerogel may be carbonized (e.g., by pyrolysis) to form a carbon aerogel, which can have properties (e.g., pore volume, pore size distribution, morphology, etc.) that differ or overlap from each other, depending on the precursor materials and methodologies used.

### Organic Aerogels

Organic aerogels are generally formed from carbon-based polymeric precursors. Such polymeric materials include, but are not limited to resorcinol formaldehydes (RF), polyimide, polyacrylate, polymethyl methacrylate, acrylate oligomers, polyoxyalkylene, polyurethane, polyphenoll, polybutadiene, polybutadiene, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one example, organic RF aerogels are typically made from the sol-gel polymerization of resorcinol or melamine with formaldehyde under alkaline conditions.

In certain aspects, aerogels of the present disclosure comprise a polyamic acid, a polyimide, or combination thereof, or are carbon aerogels obtained (i.e., derived) from a polyamic acid or polyimide by carbonization. In particular aspects, the aerogel comprises a polyamic acid, a polyimide, or combination thereof, or is obtained by pyrolysis of a polyamic acid, a polyimide, or combination thereof. In some aspects, the polyamic acid or polyimide is prepared in an aqueous solution (i.e., via an aqueous sol-gel process). Reference herein to an aqueous solution or aqueous sol-gel process means that the solution or aqueous sol-gel process is substantially free of any organic solvent. The term “substantially free” as used herein in the context of organic solvents means that no organic solvent has been intentionally added, and no organic solvent is present beyond trace amounts. For example, in certain aspects, an aqueous solution can be characterized as having less than 1% by volume of organic solvent, or less than 0.1%, or less than 0.01%, or even 0% by volume of organic solvent.

Utilization of an aqueous sol-gel process is advantageous in providing rapid gelation, making the process amenable to configuration in a continuous process, for example, for preparing polyimide beads. Aqueous sol-gel processes for preparing polyamic acid and polyimide gel materials are economically preferable to conventional methods of such materials (e.g., expensive organic solvents are avoided, and disposal costs are minimized) and “green” (i.e., beneficial from an environmental standpoint, as potentially toxic organic solvents are avoided and production of toxic byproducts is minimized or eliminated), and are advantageous in potentially reducing the overall number of operations which must be performed to provide carbon or polyamic acid/polyimide gel materials. As disclosed in International Patent Application Publication No. WO2022/125835, and International Patent Application PCT/US2023/016821, each of which is incorporated by reference herein in their entirety, polyamic acid and polyimide gels can be prepared in water, in monolithic or bead form, the gels may be converted to aerogels, which possess nanostructures with similar properties to aerogels prepared by a conventional organic solvent-based process, and the aerogels optionally pyrolyzed to form a corresponding carbon aerogel.

In some aspects, the aerogel of the present disclosure is a polyamic acid aerogel, in monolithic or bead form, wherein the polyamic acid is prepared by acidification of an aqueous solution of a polyamic acid. In some aspects, the polyamic acid is dissolved in water in the presence of a base (e.g., an alkali metal hydroxide or non-nucleophilic amine base). In other aspects, the polyamic acid is prepared in situ under aqueous conditions, directly forming the polyamic acid salt solution. In some aspects, the polyamic acid is any commercially available polyamic acid. In other aspects, the polyamic acid has been previously formed (“pre-formed”) and isolated, e.g., prepared by reaction of a diamine and a tetracarboxylic dianhydride in an organic solvent according to conventional synthetic methods. In some aspects, the aqueous solution of a polyamic acid salt is prepared in situ by e.g., reaction of a diamine and a tetracarboxylic acid dianhydride in the presence of a non-nucleophilic amine, providing an aqueous solution of the polyamic acid ammonium salt. Suitable methods for preparing polyamic acid aerogels under such aqueous conditions are disclosed in WO2022/125835 and PCT/US2023/016821, previously incorporated by reference.

In some aspects, the aerogel of the present disclosure is a polyimide aerogel, in monolithic or bead form, wherein the polyimide is prepared by thermal or chemical imidization of a polyamic acid in aqueous solution. Suitable methods of forming monoliths and beads (e.g., utilizing droplet or emulsion-based processes) under such aqueous conditions are disclosed in WO2022/125835 and PCT/US2023/016821, previously incorporated by reference.

### Organic/Inorganic Hybrid Aerogels

In some aspects, the aerogel of the present disclosure is an organic/inorganic hybrid aerogel. Organic/inorganic hybrid aerogels are mainly comprised of organically modified silica (“ormosil”). These ormosil materials include organic components that are covalently bonded to a silica network. Ormosils are typically formed through the hydrolysis and condensation of organically modified silanes (R—Si(OX)₃), with traditional alkoxide precursors (Y(OX)₄). In these formulas, X may represent, for example, CH₃, C₂H₅, C₃H₇, C₄H₉; Y may represent, for example, Si, Ti, Zr, or Al; and R may be any organic fragment such as methyl, ethyl, propyl, butyl, isopropyl, methacrylate, acrylate, vinyl, epoxide, and the like. The organic components in ormosil aerogels may also be dispersed throughout or chemically bonded to the silica network.

### Silicon Particles

The silicon is generally present in the composite material of the disclosure as silicon particles. Within the context of the present disclosure, the term “silicon particles” refers to silicon or silicon-based materials with a range of particle sizes. The particle size of the silicon in the composite material may vary. Silicon particles of the present disclosure can be nanoparticles, e.g., particles with two or three dimensions in the range of about 1 nm to about 150 nm. Silicon particles of the present disclosure can be fine particles, e.g., micron-sized particles with a maximum dimension, e.g., a diameter for a substantially spherical particle, in the range of about 150 nm to about 10 micrometers or larger. For example, silicon particles of the present disclosure can have a maximum dimension, e.g., a diameter for a substantially spherical particle, of about 10 nm, 50 nm, 60 nm, 80 nm, 100 nm, 120 nm, 130 nm, 140 nm, 150 nm, 180 nm, 200 nm, 500 nm, 1 micrometer, 1.5 micrometers, 2 micrometers, 3 micrometers, 5 micrometers, 10 micrometers, 20 micrometers, 40 micrometers, 50 micrometers, 100 micrometers, or in a range between any two of these values.

In some aspects, the silicon particles can be monodispersed or substantially monodispersed. In other aspects, the silicon particles can have a particle size distribution. Within the context of the present disclosure, the dimensions of silicon particles are provided based upon the median of the particle size distribution, i.e., the D50. In some aspects, the silicon in the composite material has an average particle size of about 1 μm or less. In some aspects, the silicon in the composite material has a particle size distribution D50 of about 10 nm to about 100 micrometers. In some aspects, the silicon in the composite material has a particle size distribution D50 of about 10 nm, 50 nm, 60 nm, 80 nm, 100 nm, 120 nm, 130 nm, 140 nm, 150 nm, 180 nm, 200 nm, 500 nm, 1 micrometer, 1.5 micrometers, 2 micrometers, 3 micrometers, 5 micrometers, 10 micrometers, 20 micrometers, 40 micrometers, 50 micrometers, 100 micrometers, or in a range between any two of these values.

Silicon particles of the present disclosure can be silicon wires, crystalline silicon, amorphous silicon, silicon alloys, silicon oxides (SiOₓ), and any combinations thereof. The particles, e.g., particles of electroactive materials such as silicon particles, can have various shapes to aspects disclosed herein. In some aspects, silicon particles disclosed herein can be substantially spherical. In other aspects, particles of electroactive materials can be substantially planar, cubic, obolid, elliptical, disk-shaped, or toroidal.

In an example, prior to formation of a sacrificial layer, the silicon particle (e.g., silicon nanoparticle) surface can be modified with functional groups that can aid in dispersing the silicon particles in a porous network. In another example, formation of the sacrificial layer may further aid in dispersing the silicon particles in a porous network. In an example, the porous network can be a sol-gel, aerogel, xerogel, foam structure, among others. In some aspects, the porous network is carbonized to obtain three-dimensional carbon network of the present disclosure according to multiple aspects disclosed herein.

For example, functional groups can be grafted onto the surface of the silicon particles by covalent bonds. Before functionalization, the surface of the silicon particles includes silane groups, such as silicon hydride, and/or silicon oxide groups. In some aspects, at least a portion of those silane and silicon oxide groups can be present in combination with the bonded functional groups after functionalization of the surface of the silicon particle, e.g., the silicon particle surface can include silane groups and the covalently attached functional groups, silicon oxide groups and the covalently attached functional groups, or both silane and silicon oxide groups and the covalently attached functional groups. The presence of the functional groups on the surface of the silicon particles can be detected by various techniques, for example, by infrared spectroscopy.

The surface of the silicon particles can be functionalized with hydrophilic groups to aid in improved dispersion within the porous network. Without being bound by theory, the functionalization with hydroxide groups creates increased covalent bonding between the surface groups on the silicon particles and the porous network. As a result, the functionalized silicon particles can be uniformly dispersed within the porous network. For example, hydrophilic hydroxide groups can be grafted to the surface of the particles by unsaturated glycol to increase the hydrophilicity of silicon particle surfaces. Increasing the hydrophilicity of the silicon particles allows for the particles to be and remain more uniformly dispersed in the network and remain uniformly dispersed in the network in any additional processing (e.g., pyrolysis). In an example, functionalization via glycol can improve the dispersion of silicon particles within a polyimide sol-gel and/or aerogel or carbon aerogel. Any suitable glycol can be used including, but not limited to, ethylene glycol methyl ether methacrylate, poly(ethylene glycol) methyl ether methacrylate, among others.

In some aspects, the individual silicon particles are dispersed heterogeneously throughout the three-dimensional carbon network. In some aspects, the individual silicon particles are dispersed homogenously throughout the three-dimensional carbon network. The expression “homogenously dispersed” refers to a distribution of the Si particles throughout the three-dimensional carbon network without large variations in the local concentration across the accessible network surface.

In some aspects, about 30 wt % to 70 wt %, about 20 wt % to about 50 wt % of the dispersed individual silicon particles within the plurality of silicon particles are in an agglomerated state. In some aspects, less than about 30 wt %, less than about 20 wt %, less than about 10 wt % of the dispersed individual silicon particles within the plurality of silicon particles are in an agglomerated state. In some aspects, homogenously distributed Si particles may refer to a distribution of the plurality of Si particles throughout the porous polymer network having less than about 30 wt %, less than about 20 wt %, less than about 10 wt % of the dispersed individual silicon particles within the plurality of silicon particles in an agglomerated state.

### Lithium Additives

Lithium additives can be added to the composite material. Lithium additives can include lithium metal and/or lithium salts. The lithium additive, in some aspects, is less than about 30% by weight, less than about 25% by weight, less than 20% by weight, less than 15% by weight or less than 10% by weight of the composite material. Exemplary lithium salts that can used as an additive for the composite material include, but are not limited to, dilithium tetrabromonickelate (II), dilithium tetrachlorocuprate (II), lithium azide, lithium benzoate, lithium bromide, lithium carbonate, lithium chloride, lithium cyclohexanebutyrate, lithium fluoride, lithium formate, lithium hexafluoroarsenate (V), lithium hexafluorophosphate, lithium hydroxide, lithium iodate, lithium iodide, lithium metaborate, lithium perchlorate, lithium phosphate, lithium sulfate, lithium tetraborate, lithium tetrachloroaluminate, lithium tetrafluoroborate, lithium thiocyanate, lithium trifluoromethanesulfonate, and lithium trifluoromethanesulfonate.

### Sacrificial Particles

In exemplary aspects, the composite material includes sacrificial particles. In some aspects, sacrificial particles of the present disclosure are made from sacrificial materials. In some aspects, sacrificial particles of the present disclosure include sacrificial materials.

Within the context of the present disclosure, the term “sacrificial material” refers to a material that is intended to be sacrificed or at least partially removed in response to mechanical, thermal, chemical and/or electromagnetic conditions experienced by the material. For example, the sacrificial material can decompose when exposed the high temperatures or high and/or continuous stress.

The sacrificial material can be selected from the group consisting of siloxanes, polyolefins, polyurethanes, phenolics, melamine, cellulose acetate, and polystyrene. In some cases, material layer is in the form of foam. In some aspects, the sacrificial material can be worn away due to exposure to mechanical (such as cyclical) loads. In some aspects, sacrificial layer decomposes after exposure to a singular mechanical, chemical and/or thermal event.

In some aspects, the onset temperature of chemical decomposition of the sacrificial material is in the range of about 100° C. to about 700° C., about 100° C. to about 500° C., about 200° C. to about 400° C. The sacrificial particles can be made of polymers, metals, natural and synthetic organics, salts, ceramic compounds or combination thereof.

Polymers for use in the sacrificial material can be selected from a wide variety of thermoplastic resins, blends of thermoplastic resins, or thermosetting resins. Examples of thermoplastic resins that can be used include polyacetals, polyacrylics, styrene acrylonitrile, polyolefins, acrylonitrile-butadiene-styrene, polycarbonates, polystyrenes, polyethylene terephthalates, polybutylene terephthalates, polyamides such as, but not limited to Nylon 6, Nylon 6,6, Nylon 6,10, Nylon 6,12, Nylon 11 or Nylon 12, polyamideimides, polyarylates, polyurethanes, ethylene propylene rubbers (EPR), polyarylsulfones, polyethersulfones, polyphenylene sulfides, polyvinyl chlorides, polysulfones, polyetherimides, polytetrafluoroethylenes, fluorinated ethylene propylenes, polychlorotrifluoroethylenes, polyvinylidene fluorides, polyvinyl fluorides, polyetherketones, polyether etherketones, polyether ketone ketones, and the like, or a combination comprising at least one of the foregoing thermoplastic resins.

Examples of blends of thermoplastic resins that can be used in the sacrificial material include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, polyethylene terephthalate/polybutylene terephthalate, styrene-maleic anhydride/acrylonitrile-butadiene-styrene, polyether etherketone/polyethersulfone, styrene-butadiene rubber, polyethylene/nylon, polyethylene/polyacetal, ethylene propylene rubber (EPR), and the like, or a combination comprising at least one of the foregoing blends.

Examples of polymeric thermosetting resins that can be used in the sacrificial material include polyurethanes, epoxies, phenolics, polyesters, polyamides, silicones, and the like, or a combination comprising at least one of the foregoing thermosetting resins. Blends of thermosetting resins as well as blends of thermoplastic resins with thermosetting resins can be used.

In some aspects, the sacrificial particles comprise a polymer having a pyrolysis yield of less than 30 wt %, less than 20 wt %, less than 18 wt %, less than 15 wt %, less than 10 wt %, less than 8.0 wt %, or less than 5.0 wt %.

In some aspects, the sacrificial particles are formed from a material selected from polymethylmethacrylate (PMMA), polyvinylpyrrolidone (PVP), polyvinyl acetate PVAc), polyvinyl alcohol (PVA), polyacrylonitrile (PAN), polypropylene oxide (PEO), polypropylene oxide (PPO), polyethyleneimine (PEI), polyurethane, poly(3,4-ethylenedioxythiophene, PEDOT), polyvinylbutyral, polyethylene oxide copolymer, polypropylene oxide copolymer, polycarbonate (PC), polyvinylchloride (PVC), polycaprolactone, polyvinylidene fluoride, polystyrene or combination thereof.

In some aspects, the sacrificial particles comprise poly-(styrene), poly-(ester), poly-(methacrylate), poly-(acrylate), poly-(ethylene glycol), poly-(acid amides), poly-(norborene), or combination thereof. In one aspect, the sacrificial particles comprise poly(methyl methacrylate).

The sacrificial particles are typically provided from the same source and have a known, desired particle size, shape, porosity and other material attributes that are substantially similar. In some examples, the sacrificial particles have a diameter of less than 10 μm, less than 8 μm, less than 5 μm, less than 3 μm, less than 2 μm, less than 1000 nm, less than 800 nm, less than 500 nm, less than 300 nm, less than 250 nm, less than 200 nm, less than 150 nm or less than 100 nm.

### Composite Material Properties

The composite materials can be characterized by the resulting pore volume, surface area (BET) and pore size distribution.

Composite materials described herein generally include micropores (<3 nm), mesopores (3 nm-50 nm), and macropores (>50 nm). The composite materials described herein include a three-dimensional carbon network having a substantial amount of macropores. In some aspects, the total level of porosity of the three-dimensional carbon network is greater than 10%, greater than 20%, greater than 30%, greater than 40%, greater than 50%, greater than 60%, or greater than 70%. In some aspects, the total level of porosity of the three-dimensional carbon network is 25% to 35%, 30% to 40%, 35% to 45%, 40% to 50%, 55% to 65%, or 60% to 70%.

In some aspects, the total pore volume of the composite material is between about 0.1 cm³/g to about 1.5 cm³/g, 0.1 cm³/g to 1.0 cm³/g, or 0.1 cm³/g to 0.5 cm³/g, 0.1 cm³/g to about 0.4 cm³/g, 0.4 cm³/g to about 1.0 cm³/g, 0.9 cm³/g to about 1.4 cm³/g.

In some aspects, the macropores constitute a volume fraction of greater than about 5%, greater than about 10%, greater than about 20%, greater than about 30%, greater than about 40%, greater than about 50%, greater than about 60%, greater than about 70%, or greater than about 80% of the total pore volume of the three-dimensional carbon network. In some aspects, the macropores constitute a volume fraction of 45% to 55%, 55% to 65%, 65% to 75%, or 70% to 80% of the total pore volume of the three-dimensional carbon network. The composite materials described herein generally have a low volume fraction of mesopores. In some aspects, the mesopores constitute a volume fraction of less than 20%, less than 10%, less than 5%, less than 2%, or less than 1% of the total pore volume of the three-dimensional carbon network. In some aspects, the mesopores constitute a volume fraction of 10% to 20%, 5% to 10%, or 1% to 5% of the total pore volume of the three-dimensional carbon network.

The composite materials described herein include a higher percentage of micropores compared to mesopores. In some aspects, the micropores constitute a volume fraction of less than 80%, less than 70%, less than 65%, less than 55%, less than 50%, less than 45%, less than 40%, less than 35%, less than 30%, less than 25%, less than 20%, less than 15%, or less than 10% of the total pore volume of the three-dimensional carbon network. In some aspects, the micropores constitute a volume fraction of about 10% to about 50%, about 10% to about 45%, about 10% to about 40%, about 10% to about 35%; about 10% to about 30%, about 10% to about 25%, about 10% to about 20%, about 10% to about 15%, about 15% to about 25%, about 25% to about 35%, about 35% to about 45%, or about 45% to about 55% of the total pore volume of the three-dimensional carbon network.

In some aspects, the composite materials have a skeletal density, measured using helium pycnometry, of about 1.0 g/mL to about 2.5 g/mL, about 1.5 g/mL to about 2.5 g/mL, about 1.0 g/mL to about 2.0 g/mL, or 1.0 g/mL to about 1.5 g/mL. In some aspects, the composite materials have a skeletal density, measured using mercury intrusion, of about 0.5 g/mL to about 2.5 g/mL, about 1.5 g/mL to about 2.5 g/mL, about 1.5 g/mL to about 2.0 g/mL, about 0.5 g/mL to about 2.0 g/mL, about 0.5 g/mL to about 1.5 g/mL, or about 0.5 g/mL to about 1.0 g/mL. In some aspects, the composite materials have a bulk density, measured using mercury pycnometry, of 0.5 g/mL to about 2.5 g/mL, of 0.5 g/mL to about 2.0 g/mL, about 0.5 g/mL to about 1.5 g/mL, or about 0.5 g/mL to about 1.0 g/mL.

The composite material properties can be determined using mercury intrusion porosity and helium pycnometry experiments. Mercury intrusion porosity can be used to determine porosity, pore size distribution and pore volume to solid particles. During a typical mercury intrusion porosity, a pressurized chamber is used to force mercury into the voids in a porous substrate. As pressure is applied, mercury fills the larger pores first. As the pressure increases, the mercury can enter into smaller pores. The mercury pycnometry can access and measure pores greater than about 3 nm. Mercury intrusion porosity can be used measure bulk density, skeletal density and porosity. By varying testing parameters (e.g., the pressure range), pores with different sizes can be excluded. The lower pore size limit if mercury intrusion porosity is about 3 nm.

Helium pycnometry use helium gas to measure the volume of pores of a solid material. During helium pycnometry, a sample is sealed in a compartment and helium gas is added to the compartment. The helium gas penetrates into small pores in the material. After the system has equilibrated, the change in pressure can be used to determine the skeletal density of the solid material. The Helium pycnometry can access and measure pores greater than about 0.3 nm, for example, pores sizing from about 3 nm to about 300 nm.

Using the mercury intrusion skeletal density measurement (Hg skeletal density) tested by Mercury pycnometry, mercury intrusion bulk density (Hg bulk density) tested by Mercury pycnometry, and He skeletal density (He skeletal density) tested by Helium pycnometry various physical properties can be calculated according to the formulas below.

$$Total bead level porosity ( \% ) = \{ ( 1 - \frac{Hg bulk density}{He skeletal density} ) / 1 \} * 100 \qquad ( 1 )$$

$$Total pore volume ( {cm}^{3} / g ) = \frac{1}{Hg bulk density} * \frac{Total beads level porosity}{100} \qquad ( 2 )$$

$$Micropore volume ( {cm}^{3} / g ) = \frac{1}{Hg skeletal density} - \frac{1}{He skeletal density} \qquad ( 3 )$$

$$Micropore volume percentage ( \% , vs total pore colume ) = micropore volume / total pore volume \qquad ( 4 )$$

Mesopore volume percentage (%, vs total pore volume) can be obtained through the mercury intrusion by excluding all the pores >50 nm

$$Macropore volume percentage ( \% , vs total pore volume ) = 1 - micropore volume percentage - mesopore volume percentage \qquad ( 5 )$$

The “Hg skeletal density” (g/cm³) is measured by dividing the mass (g) of the composite material particles by the volume (cm³) of the particles, where the volume is measured by controlling (e.g., by pressure) the mercury access to pores of the particles greater than 3 nm during the measurement. This volume does not include the volume of the mercury accessible pores of the composite materials greater than 3 nm. Instead, the volume only includes the volume of the “skeleton” of the composite material particles. The volume of the pores less than 3 nm is considered as part of the skeleton and included in the skeletal density calculation.

The “Hg bulk density” is measured by dividing the mass (g) of the composite material particles by the volume (cm³) of the particles, where the volume is measured by controlling (e.g., by pressure) the mercury not to access pores of the particles during the measurement. This volume includes the volume of the pores of the composite materials, including pores greater than 3 nm and less than 3 nm.

The “He skeletal density” is measured by dividing the mass (g) of the composite material particles by the volume (cm³) of the particles, where the volume is measured by controlling (e.g., by pressure) the helium to access pores of the particles greater than 0.3 nm during the measurement. This volume does not include the volume of the helium accessible pores of the composite materials greater than 0.3 nm. Instead, the volume only includes the volume of the “skeleton” of the composite material particles. The volume of the pores less than 0.3 nm is considered as part of the skeleton and included in the skeletal density calculation.

The composite material may also include pores not accessible to either Helium nor Mercury during the helium pycnometry or mercury pycnometry tests. For example, some of pores formed by removing sacrificial particles may be enclosed in the three-dimensional network and therefore accessible to neither Helium pycnometry nor the Mercury pycnometry. These non-accessible pores are usually a very small amount in the composite materials disclosed herein. The non-accessible pores are treated as part of the volume of the skeleton without introducing significant variations.

The “total bead level porosity” (%) refers to the ratio of the volume of the pores in the composite material particles to the volume of the composite material particles. The total bead level porosity is calculated by equation (1). The total bead level porosity includes pores of greater than 0.3 nm that can be accessed by Helium and Mercury.

The “total pore volume” (cm³/g) refers to the total pore volume of unit weight of the composite material particles. The total pore volume is calculated by equation (2). The total pore volume includes pores greater than 0.3 nm that can be accessed by Helium and Mercury.

The “micropore volume” (cm³/g) refers to the micropore volume of unit weight of the composite material particles. The micropore volume (cm³/g) of the composite material is the difference between of the reciprocal (cm³/g) of the Mercury skeletal density (g/cm³) and the reciprocal (cm³/g) of the Helium skeletal density (g/cm³) according to equation (3). The micropore volume includes pores greater than 0.3 nm but less than 3 nm. The micropores are accessible by Helium but not accessible by Mercury.

The “micropore volume percentage” (%) refers to the volumetric ratio between the volume of the micropore to the total pore volume. The micropore volume percentage is calculated by equation (4).

The “mesopore volume percentage” (%) refers to the volumetric ratio between the volume of the mesopores to the total pore volume. Mesopores refers to pores between about 3 nm to about 50 nm that are accessible by Mercury. Pores below 3 nm are not accessible by Mercury. Mesopore volume percentage can be directly measured using Mercury pycnometry by excluding pores greater than 50 nm. The mesopore volume percentage can also be obtained by subtracting micropore volume percentage (calculated in equation (4)) and macropore volume percentage (measured by Mercury pycnometry) from total pore volume percentage (100%).

The “macropore volume percentage” (%) refers to the volumetric ratio between the volume of the macropores to the total pore volume. Macropores are greater than about 50 nm that are accessible by Mercury. Macropore volume percentage can be directly measured using Mercury pycnometry by excluding pores smaller than 50 nm. The macropore volume percentage can also be obtained by subtracting micropore volume percentage (calculated in equation (4)) and mesopore volume percentage (measured by Mercury pycnometry) from total pore volume percentage (100%).

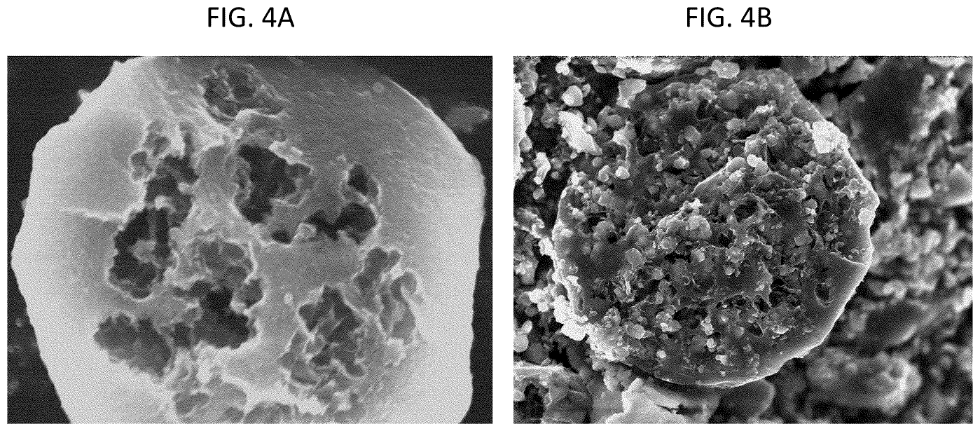

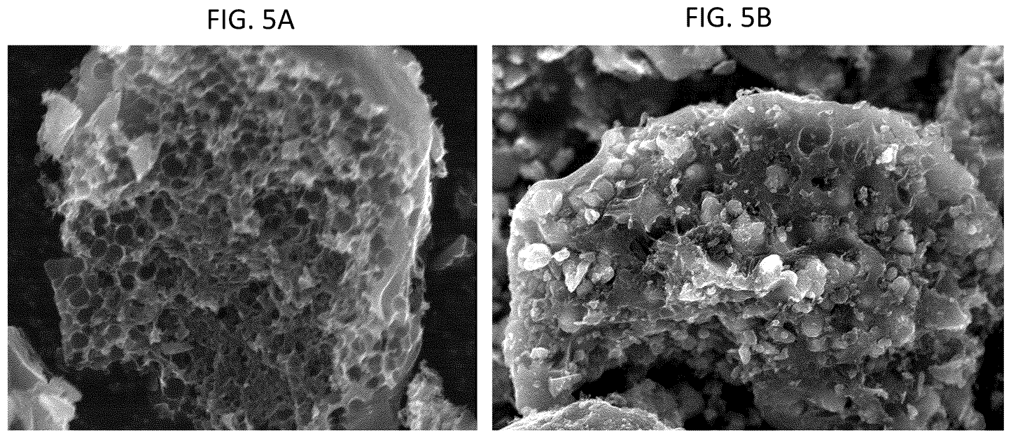

FIGS. 4A/4B and 5A/5B depict SEM images of composite materials. In FIG. 4A, a composite material made from a polyimide (PI) without additives (e.g., silicon) is shown. In FIG. 4B a composite material made from a PI with added silicon is shown. In FIG. 5A a composite material made from a PAA without additives (e.g., silicon) is shown. In FIG. 5B a composite material made from a PI with added silicon is shown. As can be seen from these figures, different conditions and reagents can create different pore distributions and pore sizes.

Control of the pore size and pore size distribution can be achieved according to the methods described herein. Various factors that can be adjusted to control pore size distribution include the method of creating the composite material, the size of the sacrificial material particles, the amount of sacrificial particles used, and the material used to form the sacrificial material. Additionally, when coated additives (e.g., coated silicon particles) are present in the composite material, the type of coating, the thickness of the coating, and the amount of coated additives present in the composite material can be used to control the pore size distribution in the composite material. Table 1 lists helium (He) skeletal density, mercury (Hg) skeletal density, mercury (Hg) bulk density and BET surface area of composite materials formed under different conditions. Table 2 lists the total bead level porosity (%), total pore volume, and micropore, mesopore, and macropore distribution of composite materials formed under different conditions.

TABLE 1
Densities of composite materials formed under different conditions

| | Skeletal | Skeletal | Bulk |
|---|---|---|---|
| | Density | Density | Density |
| Composite Material | (He, g/cm³) | (Hg, g/cm³) | (Hg, g/cm³) |
| Aerogel Si/C | 1.7-2.5 | 2.0-2.3 | 0.5-1.0 |
| Aerogel PMMA Si/C | 2.0-2.5 | 1.0-1.5 | 0.5-1.0 |
| Xerogel Si/C | 1.7-2.3 | 1.5-2.0 | 1.0-1.5 |
| Xerogel Si/C—slower | 2.0-2.5 | 1.5-2.0 | 1.0-1.5 |
| evaporation rate | | | |
| PI Xerogel PMMA Si/C | 1.7-2.3 | 1.5-2.0 | 1.5-2.0 |
| PAA Xerogel PMMA Si/C | 1.5-2.0 | 1.0-1.5 | 0.5-1.5 |
| PI Xerogel PMMA | 2.0-2.5 | 1.5-2.0 | 1.0-1.5 |
| Si/C—Spray Dry | | | |
| PI_II Xerogel PMMA C | 1.5-2.0 | 1.0-1.5 | 0.5-1.0 |
| PI Xerogel PMMA C | 1.5-2.0 | 1.5-2.0 | 1.0-1.5 |
| PAA Xerogel PMMA C | 1.5-2.0 | 1.0-1.5 | 0.5-1.5 |
| PI Xerogel | 2.0-2.5 | 1.0-1.5 | 0.5-1.0 |
| PMMA C—Spray Dry | | | |

TABLE 2
Porosities of composite materials formed under different conditions

| | Total | | Micro- | Meso- | Macro- |
|---|---|---|---|---|---|
| | bead | | pore | pore | pore |
| | level | Total | (% vs | (% vs | (% vs |
| | Porosity | Pore | total | total | total |
| | (% of bead | Volume | pore | pore | pore |
| Composite Material | volume) | (cm³/g) | volume) | volume) | volume) |
| Aerogel Si/C | 60-70 | 0.5-1.5 | 1-5 | 45-55 | 40-50 |
| Aerogel PMMA Si/C | 70-80 | 1.0-2.0 | 10-20 | 70-80 | 5-15 |
| Xerogel Si/C | 25-35 | 0.1-0.5 | 80-90 | 1-5 | 5-15 |
| Xerogel Si/C | 40-50 | 0.1-0.5 | 25-35 | 1-5 | 65-75 |
| Slower solvent | | | | | |
| evaporation rate | | | | | |
| PI Xerogel PMMA | 25-35 | 0.1-0.5 | 35-45 | 1-5 | 55-65 |
| Si/C | | | | | |
| PAA Xerogel | 35-45 | 0.1-0.5 | 55-75 | 5-10 | 25-35 |
| PMMA Si/C | | | | | |
| PI Xerogel PMMA | 35-45 | 0.1-0.5 | 15-25 | 1-5 | 70-80 |
| Si/C Spray Dry | | | | | |
| PI_II Xerogel | 55-65 | 0.5-1.5 | 45-55 | 1-5 | 45-55 |
| PMMA C | | | | | |
| PI Xerogel PMMA C | 30-40 | 0.1-0.5 | 10-20 | 10-20 | 65-75 |
| PAA Xerogel | 40-50 | 0.1-0.5 | 70-80 | 1-5 | 20-30 |
| PMMA C | | | | | |
| PI Xerogel PMMA C | 60-70 | 0.5-1.5 | 35-45 | 1-5 | 55-65 |
| Spray Dry | | | | | |

Referring to Table 1 and Table 2, “Aerogel Si/C” is a composite material made by mixing silicon particles with a sol gel (e.g., polyimide precursor) to form beads having silicon particles embedded in the bead, which is processed by supercritical drying followed by carbonization to form an aerogel. “Aerogel PMMA Si/C” is a composite material made by mixing silicon particles and PMMA particles with a sol gel (e.g., polyimide precursor) to form beads having silicon particles and PMMA particles embedded in the bead, which is processed by supercritical drying followed by carbonization to form an aerogel. “Xerogel Si/C” is a composite material made by mixing silicon particles and with a sol gel (e.g., polyimide precursor) to form beads having silicon particles embedded in the bead, which is processed by drying and pyrolysis to form a xerogel. “Xerogel Si/C-slower solvent evaporation rate” is a composite material made by mixing silicon particles and with a sol gel (e.g., polyimide precursor) to form beads having silicon particles embedded in the bead, which is processed by drying and pyrolysis to form a xerogel. The drying step of the “Xerogel Si/C-slower solvent evaporation rate” is slower than the drying step of the “Xerogel Si/C”. The slower evaporation rate is employed to avoid the collapse of the gel network due to the capillary force of the evaporating solvent, thereby preserving more pores in the final carbonized xerogel particles. “PI Xerogel PMMA Si/C” is a composite material made by mixing silicon particles and PMMA particles with a polyimide precursor sol gel to form beads having silicon particles and PMMA particles embedded in the bead, which is processed by drying and pyrolysis to form a xerogel. “PAA Xerogel PMMA Si/C” is a composite material made by mixing silicon particles and PMMA particles with polyamic acid (PAA) to form PAA beads having silicon particles and PMMA particles embedded in the bead, which is processed by drying and pyrolysis to form a xerogel. “PI Xerogel PMMA Si/C-Spray Dry” is a composite material made by mixing silicon particles and PMMA particles with a polyimide precursor sol gel to form beads (using a spray dry process) having silicon particles and PMMA particles embedded in the bead, which is processed by pyrolysis to form a xerogel. “PI_II Xerogel PMMA C” is a composite material made by mixing PMMA particles with a polyimide precursor sol gel to form beads having PMMA particles embedded in the bead, which is processed by drying and pyrolysis to form a xerogel. “PI Xerogel PMMA C” is a repeat sample of “PI_II Xerogel PMMA C”. “PAA Xerogel PMMA C” is a composite material made by mixing PMMA particles with polyamic acid (PAA) to form PAA beads having PMMA particles embedded in the bead, which is processed by drying and pyrolysis to form a xerogel. “PI Xerogel PMMA C-Spray Dry” is a is a composite material made by mixing PMMA particles with a polyimide precursor sol gel to form beads (using a spray dry process) having PMMA particles embedded in the bead, which is processed by pyrolysis to form a xerogel. Further description of the synthesis of these composite materials can be found in U.S. Provisional Patent Application No. 63/390,832 entitled “Silicon Nanoparticles Comprising a Sacrificial Layer, Composite Materials Including Them, Preparation and Uses Thereof”, filed Jul. 20, 2022; U.S. Provisional Patent Application No. 63/390,838 entitled “Composite Materials Comprising Void Space, Preparation, and Uses Thereof”, filed Jul. 20, 2022; U.S. Provisional Patent Application No. 63/410,652 entitled “Porous Carbon Materials Comprising a Carbon Additive”, filed Sep. 28, 2022; U.S. Provisional Patent Application No. 63/390,845 entitled “Composite Materials with Tunable Porosity, Preparation, and Uses Thereof”, filed Jul. 20, 2022; and U.S. Provisional Patent Application No. 63/390,825 entitled “Functionalized Silicon Nanoparticles, Composite Materials that Comprise Them, Preparation and Uses Thereof”, filed Jul. 20, 2022, all of which are incorporated herein by reference.

### Lithium-Ion Batteries

A basic embodiment of a lithium-ion battery includes a cathode; an anode in electrical communication with the cathode; an electrolyte disposed between the anode and the cathode; and a separator also disposed between the anode and the cathode.

The electrolyte is an ionically conductive material and may include solvents, ionic liquids, metal salts, ions such as metal ions or inorganic ions, polymers, ceramics, and other components. An electrolyte may be an organic or inorganic solid or a liquid, such as a solvent (e.g., a non-aqueous solvent) containing dissolved salts. Non-aqueous electrolytes can include organic solvents, such as, cyclic carbonates, linear carbonates, fluorinated carbonates, benzonitrile, acetonitrile, tetrahydrofuran, 2-methyltetrahydrofuran, γ-butyrolactone, dioxolane, 4 methyldioxolane, N,N-dimethylformamide, N,N-dimethylacetamide, N,N-dimethylsulfoxide, dioxane, 1,2-dimethoxyethane, sulfolane, dichloroethane, chlorobenzene, nitrobenzene, diethyleneglycol, dimethylether, and mixtures thereof. Example salts that may be included in electrolytes include lithium salts, such as LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y-1}SO₂), (where x and y are natural numbers), LiCl, LiI, and mixtures thereof. In some aspects, the liquid molecules comprise an electrolyte solvent (an electrolyte). The electrolyte solvent of the present disclosure can be selected from any of the suitable electrolyte described above. Particularly, the electrolyte is selected from ethylene carbonate (EC), diethyl carbonate (DEC), dimethyl carbonate (DMC), fluoroethylene carbonate (FEC), fluorinated ether (F-EPE), 1,3-dioxolane (DOL), dimethoxyethane (DME), or combination thereof.

The separators are typically thin, porous or semi-permeable, insulating films with high ion permeabilities. The separators can be composed of polymers, such as olefin-based polymers (e.g., polyethylene, polypropylene, and/or polyvinylidene fluoride). If a solid polymer electrolyte is used as the electrolyte, the solid polymer electrolyte may also act as the separator.

The anodes are composed of an active anode material that takes part in an electrochemical reaction during the operation of the battery. Example anode active materials include elemental materials, such as lithium; alloys including alloys of Si and Sn, or other lithium compounds; and intercalation host materials, such as graphite. By way of illustration only, the anode active material may include a metal and/or a metalloid alloyable with lithium, an alloy thereof, or an oxide thereof. Metals and metalloids that can be alloyed with lithium include Si, Sn, Al, Ge, Pb, Bi, and Sb. For example, an oxide of the metal/metalloid alloyable with lithium may be lithium titanate, vanadium oxide, lithium vanadium oxide, SnO₂, or SiOₓ (0<x<2).

The cathodes are composed of an active cathode material that takes part in an electrochemical reaction during the operation of the battery. The active cathode materials may be lithium composite oxides and include layered-type materials, such as LiCoO₂; olivine-type materials, such as LiFePO₄; spinel-type materials, such as LiMn₂O₄; and similar materials. The spinel-type materials include those with a structure similar to natural spinal LiMn₂O₄, that include a small amount nickel cation in addition to the lithium cation and that, optionally, also include an anion other than manganate. By way of illustration, such materials include those having the formula LiNi_{(0.5-x)}Mn_{1.5}MₓO₄, where 0≤x≤0.2 and M is Mg, Zn, Co, Cu, Fe, Ti, Zr, Ru, or Cr.

Within the context of the present disclosure, the term “cycle life” refers to the number of complete charge/discharge cycles that an anode or a battery (e.g., LIB) is able to support before its capacity falls under about 80% of its original rated capacity. Cycle life may be affected by a variety of factors, for example mechanical strength of the underlying substrate (e.g., carbon aerogel) and maintenance of interconnectivity of the aerogel. It is noted that these factors actually remaining relatively unchanged over time is a surprising aspect of certain examples of the present disclosure. Cycle life may be determined by methods known in the art, for example including, but not limited to, cycle testing, where battery cells are subject to repeated charge/discharge cycles at predetermined current rates and operating voltage. Within the context of the present disclosure, measurements of cycle life are acquired according to this method, unless otherwise stated. Energy storage devices, such as batteries, or electrode thereof, can have a cycle life of about 25 cycles or more, 50 cycles or more, 75 cycles or more, 100 cycles or more, 200 cycles or more, 300 cycles or more, 500 cycles or more, 1000 cycles or more, or in a range between any two of these values.

The present disclosure includes an electrical energy storage device with at least one anode comprising the composite material of present technology as described herein, at least one cathode, and an electrolyte with lithium ions. The electrical energy storage device can have a first cycle efficiency (i.e., a cell's coulombic efficiency from the first charge and discharge) of at least 10%, 20%, 30%, 40%, 50%, 60%, 70%, any intervening value (e.g., 65%) or in a range between any two of these values (e.g., ranges from about 30% to about 50%). As previously described herein, reversible capacity can be at least 150 mAh/g. The at least one cathode can be selected from the group consisting of conversion cathodes such as lithium sulfide and lithium air, and intercalation cathodes such as phosphates and transition metal oxides.

According to different aspects, the composite materials of the present disclosure may be applied to both the positive electrode and the negative electrode of electrochemical energy storage devices, or to the electrodes individually (either the positive electrode or the negative electrode). In various aspects, a cathode, anode, or solid-state electrolyte material is coated with the composite materials of the present technology.

### EXEMPLIFICATION

The following examples are included to demonstrate non-limiting aspects of the technology. However, those of skill in the art should, in light of the present disclosure, appreciate that many changes can be made in the specific aspects which are disclosed and still obtain a like or similar result without departing from the spirit and scope of the technology.

### Example 1: Synthesis of Carbon Aerogel Microbeads (Reference)

Reference carbon aerogel beads were prepared by imidization of an emulsified aqueous solution of a polyamic acid triethylammonium salt followed by pyrolysis of the resulting polyimide gel beads.

Polyimide gel beads were prepared at a target density of about 0.073 g/cm³. A solution of 1,4-phenylenediamine in water was prepared by mixing PDA (7.02 g; 65 mmol) with water (211 g), followed by heating at 60° C. until complete dissolution occurred (approximately 8 minutes). The solution was cooled to room temperature and stirred. Triethylamine (21.8 ml; 2.4:1 mol/mol ratio to PMDA) was added, followed by stirring for 3 minutes. To this mixture was added pyromellitic dianhydride (PMDA; 14.2 g; 1:1 mol/mol ratio relative to PDA) followed by stirring for 3 hours at room temperature. To the resulting triethylammonium salt solution of the polyamic acid, acetic anhydride (26.4 ml; 4.3 mol/mol ratio relative to PMDA) was added, and the mixture was stirred for 50 seconds. At the end of that period, the sol was poured into an immiscible phase under high shear using a Ross mixer at 4000 rpm. The immiscible phase was prepared by dissolving 9.75 g of surfactant Hypermer® B246SF (HLB of 6) in 650 mL of mineral spirits (mineral spirits to PI sol ratio of 5:1). The mixture was stirred at 4000 rpm with the Ross mixer for 3 minutes. After standing for 1 hour, the mixture was removed from the Ross mixer and the mineral spirits phase was decanted. The beads were washed with ethanol and collected by filtration. The beads were washed several times with ethanol to fully remove residual water and mineral spirits, and were then dried at 68° C. The dry polyimide beads were pyrolyzed at 1050° C. for 2 hours under nitrogen.

### Example 2: Synthesis of Sacrificial Particles (PMMA Nanospheres) without Crosslinking

Water (80 grams) and monomeric methyl methacrylate (20 grams) were added to a beaker and the solution was stirred for 15 minutes on a hot plate at 500 RPM with the solution temperature controlled at 80° C. Ammonium persulfate (1.8 grams) was added to the solution as an initiator. The stirring speed was then lowered to 300 RPM after 60 minutes. When the color of the solution changed from transparent to milky, the stirring speed was raised to 500 RPM again. The solution was stirred for another 180 minutes before 2.1 gram of polymer modifier (hydroxyethyl) methacrylate was added. The solution temperature was changed to 60° C. and the solution was stirred overnight. The synthesis of PMMA nanospheres in emulsion was complete by the next morning.

### Example 3: Synthesis of Sacrificial Particles (PMMA Nanospheres) with Crosslinking

Water (80 grams) and monomeric methyl methacrylate (20 grams) were added to a beaker and the solution was stirred for 15 minutes on a hot plate at 500 RPM with the solution temperature controlled at 80° C. Ammonium persulfate (1.8 grams) was added to the solution as an initiator. Ammonium persulfate (1.8 grams) was added to the solution as an initiator. The stirring speed was then lowered to 300 RPM after 60 minutes. When the color of the solution changed from transparent to milky, the stirring speed was raised to 500 RPM again. 1,3-Butanediol dimethacrylate (1.8 grams) was added to the solution as a crosslinking reagent immediately. The solution was stirred for another 180 minutes before polymer modifier ((hydroxyethyl) methacrylate; 2.1 grams) was added. The solution temperature was changed to 60° C. and was stirred overnight. The synthesis of PMMA nanospheres in emulsion was completed by the next morning.

### Example 4: Oxidation of Silicon Particles

Commercially available silicon particles may or may not include oxidized (partially or completely) silicon particles. Therefore, depending on the surface functionalities of silicon particles provided by commercial providers, the oxidation step provided herein is optional.

Silicon particles (100-3000 nm; available from Evonik; 10-100 g) were either heated in the temperature range of 400-850° C. under moisture for 1-5 h or dispersed in 0.1-5M sulphochromic acid (10-1000 mL) or 1-10M H₂O₂ (hydrogen peroxide; 10-1000 mL). For the Si dispersion, it was heated to 50-120° C. for 1-10 hour under constant stirring in order to obtain hydroxyl functional groups (or silanol groups) on the surface of silicon particles. In principle, other oxidizing agents can also be used for this purpose. After 1-10 hour of stirring the solution, the solution was cooled to room temperature and centrifuged to obtain oxidized silicon particles. The obtained silicon particles were washed with 100-3000 mL volume of water for 3-5 times to remove any residual acid and dried under ambient conditions for 3-10 hours. The surface oxidation was confirmed by IR spectrum as evidenced by the reduced intensity of band at 2105 and 1993 cm-1 and the increase of band intensity at 1052 cm-1. The oxidation by heating dry powder can also be confirmed by the mass increase after the treatment.

### Example 5: Synthesis of Composite Si/C Materials Containing Macropores

In a typical synthesis, 12.7 g of p-phenylenediamine (PDA) was added to 313 g water in a beaker and stirred for 30 min until all the PDA dissolved. Then, 28.5 g of triethylamine was added to the solution and stirred for 10 min. After that, 25.5 g of benzene-1,2,4,5-tetracarboxylic anhydride was added to the above solution and stirred for 4 h. Then, 1.5-25 g PMMA nanospheres and optionally, 14.4 g oxidized Si particles, were then added to the above solution and stirred for 10 min. 51.4 g acetic anhydride was then poured into the above suspension and stirred for 50 s before pouring it all into 1200 mL mineral spirits with surfactant under mixing at 3600 rpm. The obtained emulsion was then aged overnight before filtration. After filtration, the obtained material was rinsed with ethanol for several times and dried in the oven at 70° C. The final product was obtained by carbonizing the above dried material at 800-1200° C. under inert gas atmosphere (N₂ or Ar) for 2-10 h.

While this disclosure has been particularly shown and described with reference to example aspects thereof, it will be understood by those skilled in the art that various changes in form and details may be made therein without departing from the scope of the technology encompassed by the appended claims.

What is claimed is:

1. A composite material comprising:
a three-dimensional carbon network, wherein the three-dimensional carbon network comprises micropores, mesopores, and macropores, wherein the macropores constitute a volume fraction of greater than about 50% of a total pore volume of the three-dimensional carbon network, and wherein the micropores constitute a volume fraction of about 10% to about 50% of the total pore volume of the three-dimensional carbon network; and
wherein the composite material has a skeletal density ranging from about 0.5 to about 2.5 g/cm³ as measured by mercury pycnometry.

2. The composite material of claim 1, wherein the mesopores constitute a volume fraction of less than about 10% of the total pore volume three-dimensional carbon network or less than about 5% of the total pore volume three-dimensional carbon network.

3. The composite material of claim 1, wherein the macropores constitute a volume fraction of over about 50% of a total pore volume three-dimensional carbon network, the mesopores constitute a volume fraction of less than 10% of a total pore volume three-dimensional carbon network, and the micropores constitute a volume fraction equal to the remainder of the total pore volume three-dimensional carbon network.

4. The composite material of claim 1, wherein the volume fraction of the macropores is at least 1.5 times the volume fraction of the micropores.

5. The composite material of claim 1, wherein the volume fraction of the macropores is about 1.5 times the volume fraction of the micropores to about 2.5 times the volume fraction of the micropores.

6. The composite material of claim 1, wherein the volume fraction of the macropores is at least 10 times the volume fraction of the mesopores.

7. The composite material of claim 1, wherein a total porosity of the three-dimensional carbon network is greater than about 10%.

8. The composite material of claim 1, wherein the volume of the macropores of the three-dimensional carbon network is from about 0.1 cm³/g to about 0.3 cm³/g.

9. The composite material of claim 1, wherein a total pore volume of the three-dimensional carbon network is from about 0.1 cm³/g to about 0.4 cm³/g.

10. The composite material of claim 1, wherein the composite material is in the form of a bead.

11. The composite material of claim 1, wherein the three-dimensional carbon network comprises amorphous carbon.

12. The composite material of claim 1, wherein the three-dimensional carbon network is a xerogel, an aerogel, an ambigel, an aerogel-xerogel hybrid material, an aerogel-ambigel hybrid material, an aerogel-ambigel-xerogel hybrid material, or a combination thereof.

13. The composite material of claim 1, further comprising about 20% to about 85% silicon.

14. The composite material of claim 13, wherein at least a portion of the silicon is entrapped within the three-dimensional carbon network.

15. The composite material of claim 13, wherein the silicon comprises silicon particles.

16. The composite material of claim 15, wherein the silicon particles are disposed adjacent to the macropores.

17. The composite material of claim 15, wherein the silicon particles have an oxygen content between 2% and 40%.

18. The composite material of claim 15, wherein a total volume of the macropores is about 1 to about 5 times greater than a total volume of the silicon particles.

19. The composite material of claim 13, wherein the composite material has a silicon loading of about 2 wt % to about 30 wt %, and wherein the three-dimensional carbon network has a total porosity of about 5% to about 50%, and wherein the three-dimensional carbon network has a total pore volume of about 0.10 mL/g to about 0.40 mL/g.

20. The composite material of claim 13, wherein the composite material has a silicon loading of about 30 wt % to about 70 wt %, and wherein the three-dimensional carbon network has a total porosity of about 45% to about 70%, and wherein the three-dimensional carbon network has a total pore volume of about 0.40 mL/g to about 1.0 mL/g.

21. The composite material of claim 13, wherein the composite material has a silicon loading of about 70 wt % to about 98 wt %, and wherein the three-dimensional carbon network has a porosity of about 65% to about 75%, and wherein the three-dimensional carbon network has a porosity of about 0.90 mL/g to about 1.4 mL/g.

22. The composite material of claim 1, further comprising lithium and/or a lithium salt.
